(19) United States
(12) Patent Application Publication
(10) Pub. No.: US 2025/0117611 A1
(43) Pub. Date: Apr. 10, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Hideki KUBO, Kanagawa (JP); Hiromitsu YAMAGUCHI, Kanagawa (JP); Okinori TSUCHIYA, Kanagawa (JP); Kouta MURASAWA, Kanagawa (JP)

(21) Appl. No.: 18/898,883

(22) Filed: Sep. 27, 2024

(30) Foreign Application Priority Data
Oct. 10, 2023 (JP) 2023-175107

(51) Int. Cl. G06K 15/02; B41J 2/21; C09D 11/50

(52) U.S. Cl. CPC G06K 15/1852; B41J 2/2114; C09D 11/50

(57) ABSTRACT

An image processing apparatus includes: a generation unit configured to generate printing data to cause a printing apparatus to apply an ink based on data of an image, the printing apparatus printing the image on a printing medium by using a fluorescent ink including a fluorescent component, a color ink, and a clear ink; and an output unit configured to output the printing data, in which the generation unit generates the printing data to cause the printing apparatus to apply the clear ink so as to reduce a difference between a degree of change in brightness depending on an observation angle in a region to which the fluorescent ink is applied and a degree of change in brightness depending on the observation angle in a region to which the color ink is applied.

### BACKGROUND

### Field

The present disclosure relates to a technique of printing an image by ejecting an ink onto a printing medium while scanning a printing head.

### Description of the Related Art

Because of its vibrant color development, inks using a fluorescent component (hereinafter, referred to as “fluorescent inks”) have been used for printing of a signage such as a poster and a POP display, packages of food and drink products, and the like.

Japanese Patent Laid-Open No. 2021-8112 describes an ink jet printing method that enables printing of an image with excellent fluorescence intensity by using the fluorescent ink.

A color ink that is a subtractive color mixture ink, such as cyan (C), magenta (M), yellow (Y), and black (K), used commonly in a printing apparatus includes a color material that absorbs light of a specific wavelength and develops the color by reflection or penetration of the light that is not absorbed. On the other hand, the fluorescent component included in the fluorescent ink emits light in a process of returning to a ground state again in absorbing excitation light and transitioning from the ground state to an excited state. For this reason, the fluorescent component is less dependent on a direction of incidence light and emits light uniformly in substantially all directions.

In some cases, the above-described color ink and fluorescent ink are different in characteristics of change in the brightness depending on an observation angle (hereinafter, also referred to as “deviation angle characteristics”). In a case where the deviation angle characteristics are different, there is caused a difference in the brightness between a region printed with the color ink and a region printed with the fluorescent ink depending on the observation angle. In this case, a printed product generated by printing an image with the color ink and the fluorescent ink may be observed as an image with a defect such as imbalanced colors depending on the observation angle.

### SUMMARY

An image processing apparatus of the present disclosure includes: a generation unit configured to generate printing data to cause a printing apparatus to apply an ink based on data of an image, the printing apparatus printing the image on a printing medium by using a fluorescent ink including a fluorescent component, a color ink, and a clear ink; and an output unit configured to output the printing data, in which the generation unit generates the printing data to cause the printing apparatus to apply the clear ink so as to reduce a difference between a degree of change in brightness depending on an observation angle in a region to which the fluorescent ink is applied and a degree of change in brightness depending on the observation angle in a region to which the color ink is applied.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a printing system;

FIG. 2 is a diagram illustrating a configuration of a printing apparatus;

FIGS. 3A to 3E are diagrams describing an operation to print an image by scanning of a printing head;

FIG. 4 is a schematic view illustrating expression of the image controlled by an area gradation method;

FIG. 5 is a diagram describing characteristics of an ink;

FIG. 6 is a diagram illustrating deviation angle characteristics of a fluorescent ink and a color ink;

FIG. 7 schematically illustrates the deviation angle characteristics;

FIGS. 8A and 8B are diagrams describing an example of an image defect due to a difference in the deviation angle characteristics;

FIGS. 9A and 9B are diagrams illustrating a measurement result of a sample obtained by the printing apparatus;

FIGS. 10A and 10B are schematic views illustrating the deviation angle characteristics of inks or the deviation angle characteristics of a combination of the inks;

FIG. 11 is a diagram illustrating a functional configuration of an image processing apparatus;

FIG. 12 is a flowchart illustrating a flow of processing to generate printing data;

FIG. 13 is a diagram illustrating a functional configuration of the image processing apparatus;

FIG. 14 is a flowchart illustrating a flow of processing to generate the printing data;

FIGS. 15A to 15D are diagrams illustrating a value of a ratio R and the deviation angle characteristics of the sample;

FIG. 16 is a diagram illustrating a functional configuration of the image processing apparatus;

FIG. 17 is a flowchart illustrating a flow of processing to generate the printing data; and

FIGS. 18A and 18B are diagrams illustrating an example of an LUT used to determine target deviation angle characteristics.

### DESCRIPTION OF THE EMBODIMENTS

Embodiments of a technique of the present disclosure are described below with reference to the drawings.

### Embodiment 1

### [Configuration of Printing System]

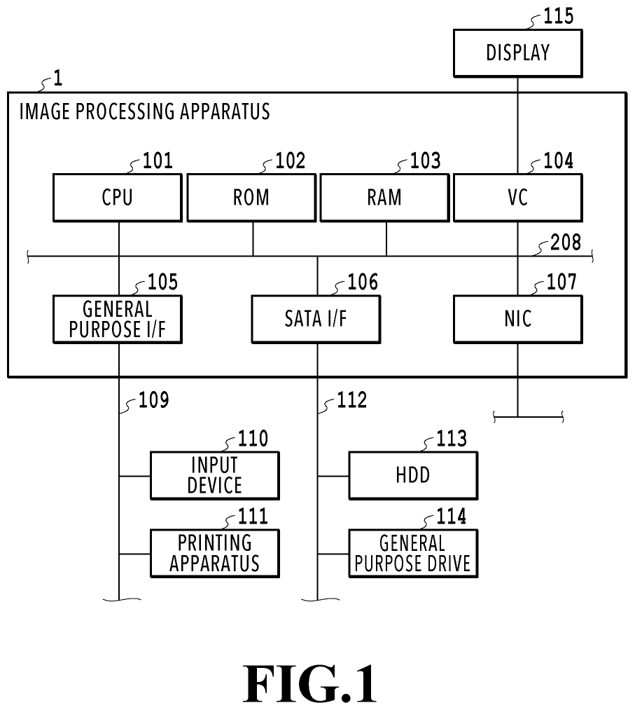

FIG. 1 is a diagram illustrating a configuration of a printing system applicable to the present embodiment. The printing system includes an image processing apparatus 1, a printing apparatus 111, an input device 110, a hard disk drive (HDD) 113, a general purpose drive 114, and a display 115.

### [Hardware Configuration of Image Processing Apparatus]

The image processing apparatus 1 is a computer, for example. The image processing apparatus 1 includes a CPU 101, a ROM 102, a RAM 103, a video card (VC) 104, a general purpose interface (I/F) 105, a serial ATA (SATA) I/F 106, and a network interface card (NIC) 107.

The CPU 101 executes an operating system (OS) or various programs stored in the ROM 102, the HDD 113, or the like while using the RAM 103 as a working memory. Additionally, the CPU 101 controls each configuration via a system bus 208. Note that, processing according to the later-described flowchart is executed with the CPU 101 deploying a program code stored in the ROM 102, the HDD 113, or the like to the RAM 103. The VC 104 is connected with the display 115.

The general purpose I/F 105 is connected with the input device 110 such as a mouse or a keyboard or the printing apparatus 111 via a serial bus 109. The SATA I/F 106 is connected with the HDD 113 or the general purpose drive 114 reading and writing various printing media via a serial bus 112. The NIC 107 inputs and outputs information to and from an external apparatus. The CPU 101 uses the various printing media mounted in the HDD 113 or the general purpose drive 114 as a storage place of various data.

The CPU 101 displays a user interface (UI) screen provided by the program on the display 115 and receives input such as a user instruction that is received via the input device 110

### [Configuration of Printing Apparatus]

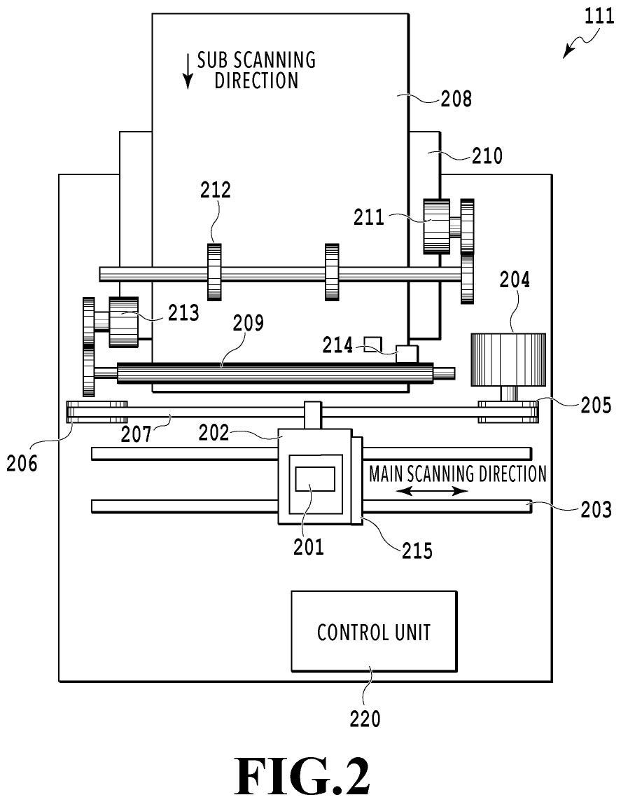

FIG. 2 is a configuration diagram of the printing apparatus 111. The printing apparatus 111 in the present embodiment is, for example, an ink jet printer that prints an image by ejecting an ink onto a printing medium.

The printing apparatus 111 includes a head cartridge 201, a carriage 202, a guide shaft 203, a main scanning motor 204, a motor pulley 205, a driven pulley 206, a timing belt 207, a printing medium 208, and a conveyance roller 209. Additionally, the printing apparatus 111 includes an automatic sheet feeder (hereinafter, called an ASF) 210, a feeding motor 211, a pickup roller 212, a line feeding motor (hereinafter, called an LF motor) 213, a paper end sensor 214, and a control unit 220.

The head cartridge 201 includes a printing head including multiple ejection ports and an ink tank that supplies the ink to this printing head. Additionally, a connector that receives a signal and the like to drive each ejection port of the printing head is provided. The ink tank included in the head cartridge 201 is formed of ink tanks corresponding to the subtractive color mixture inks (cyan, magenta, yellow, and black), a fluorescent pink ink, a first clear ink, and a second clear ink, respectively. The ink tanks are filled with the corresponding inks independently. Note that, as described later, since there are multiple types of fluorescent color inks such as the fluorescent pink ink, the ink tanks may be provided so as to be able to eject multiple types fluorescent inks.

The head cartridge 201 is mounted on the carriage 202 so as to be replaceable, and a connector holder that transfers a driving signal and the like to the head cartridge 201 via the connector is provided to the carriage 202. The carriage 202 can be moved reciprocally along the guide shaft 203. Specifically, the carriage 202 is driven via a driving mechanism such as the motor pulley 205, the driven pulley 206, and the timing belt 207 with the main scanning motor 204 as a driving source, and the position and the movement of the carriage 202 are controlled. Note that, in the present embodiment, this movement of the carriage 202 along the guide shaft 203 is called “main scanning”, and a direction of the movement is called a “main scanning direction”.

The printing medium 208 such as a printing sheet is placed on the ASF 210. In image printing, the pickup roller 212 is rotated via a gear by driving of the feeding motor 211, and the printing medium 208 is separated and fed one by one from the ASF 210. In addition, the printing medium 208 is conveyed by the rotation of the conveyance roller 209 to a printing start position facing an ejection port surface of the head cartridge 201 on the carriage 202. The conveyance roller 209 is driven via a gear with the LF motor 213 as a driving source. Determination on whether the printing medium 208 is fed and fixing of a position in the feeding are performed at a time point when the printing medium 208 passes through the paper end sensor 214. The head cartridge 201 mounted on the carriage 202 is held such that the ejection port surface protrudes downward from the carriage 202 to be parallel to the printing medium 208. The control unit 220 includes a CPU, a storage unit, or the like to receive data for forming each layer of the above-described inks from the outside and controls an operation of each part of the printing apparatus 111 based on the data.

### [Operation of Printing Apparatus]

An image printing operation of the printing apparatus 111 is described. The printing medium 208 in the present embodiment is an ink jet sheet commonly used. First, once the printing medium 208 is conveyed to a predetermined printing start position, the carriage 202 is moved above the printing medium 208 along the guide shaft 203, and each ink is ejected from the ejection port of the printing head during the movement. Then, once the carriage 202 is moved to one end of the guide shaft 203, the conveyance roller 209 conveys the printing medium 208 by a predetermined amount in a direction perpendicular to the main scanning direction of the carriage 202. In the present embodiment, this conveyance of the printing medium 208 is called “paper feeding” or “sub scanning”, and this conveyance direction is called a “paper feeding direction” or a “sub scanning direction”. Once the conveyance of the printing medium 208 by the predetermined amount ends, the carriage 202 is moved along the guide shaft 203 again. Thus, the image is printed on the printing medium 208 by repeating the scanning by the carriage 202 of the printing head and the paper feeding.

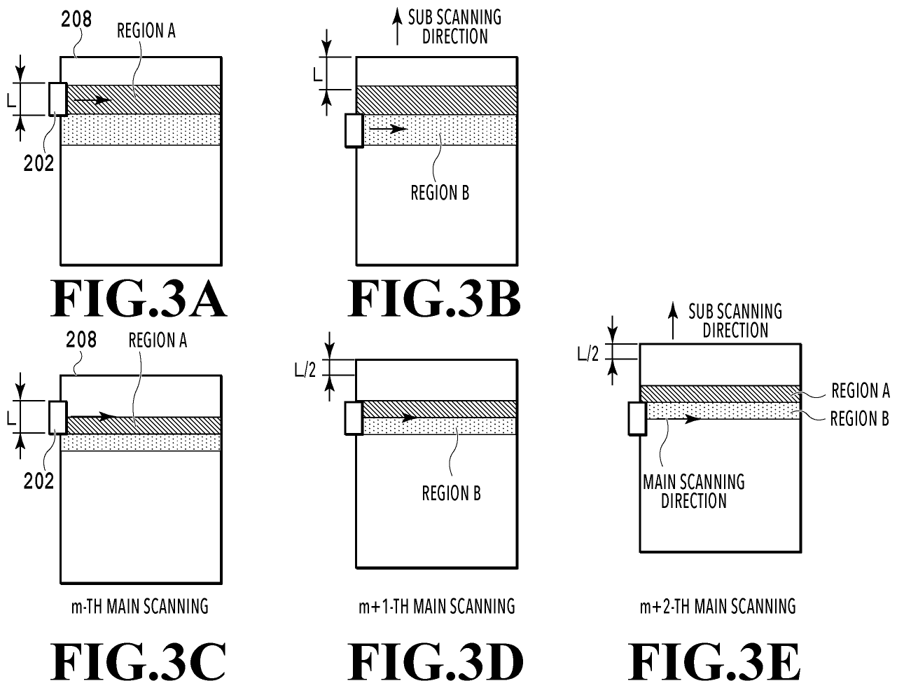

FIGS. 3A to 3E are diagrams describing an operation to print the image by scanning of the printing head above the printing medium 208. As illustrated in FIGS. 3A and 3B, the layer is formed by a width L of the printing head by the main scanning of the carriage 202, and every time printing of each line ends, the printing medium 208 is conveyed in the sub scanning direction by a distance L.

Additionally, in some cases, so-called multi-pass printing is performed to suppress image quality degradation such as irregular cycle depending on the driving accuracy of the printing head. FIGS. 3C to 3E are diagrams illustrating an example of the multi-pass printing in which printing is performed by scanning (passing) a printing target region twice. In this example, the layer is formed by the width L of the printing head by the main scanning of the carriage 202, and every time printing of each line ends, the printing medium 208 is conveyed in the sub scanning direction by a distance L/2. A region A is printed by m-th main scanning (FIG. 3C) and m+1-th main scanning (FIG. 3D) of the printing head, and a region B is printed by m+1-th main scanning (FIG. 3D) and m+2-th main scanning (FIG. 3E) of the printing head. Additionally, it is possible to form a desired layer structure on the printing medium by controlling an ink type that is printed in each pass. For example, in a case of printing using the fluorescent ink for a first pass and the clear ink for a second pass, it is possible to form a layer structure including a lower layer of the fluorescent ink and an upper layer of the clear ink.

Although FIGS. 3C to 3E illustrate the operations of the multi-pass printing in which the pass number is two (two pass printing), it is possible to change the pass number in the multi-pass printing according to desired accuracy. For example, in a case of performing n pass printing in which the pass number is n, every time printing of each line ends, the printing medium 208 is conveyed in the sub scanning direction by a distance L/n.

Note that, the printing medium 208 is not limited to paper, and it is possible to use various materials as long as it can be used for formation of a layer by the printing head.

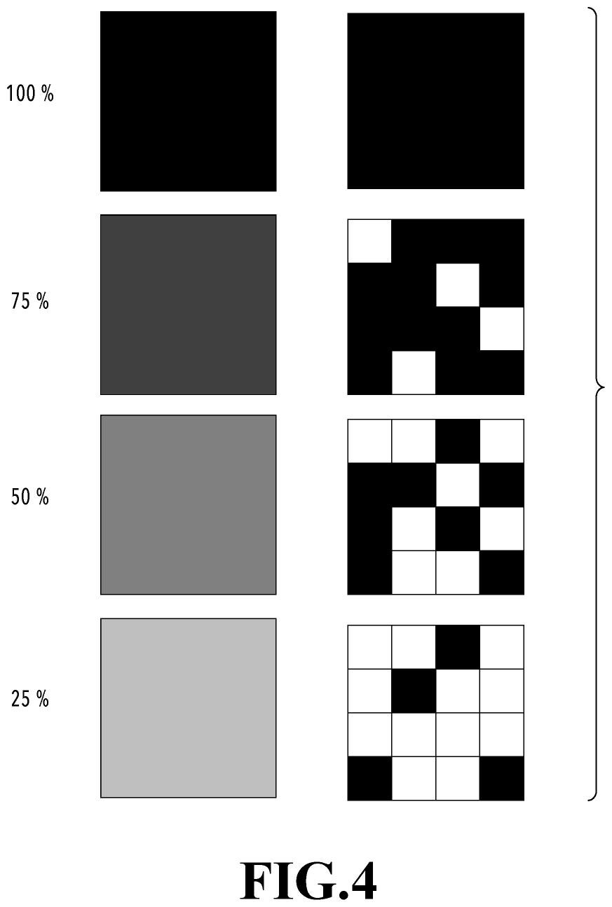

FIG. 4 is a schematic view illustrating expression of the image controlled by an area gradation method. For the sake of simple description, the printing head in the present embodiment is under binary control whether to eject an ink droplet or not. Additionally, in the present embodiment, ON and OFF of the printing by the ink ejection for each pixel defined by an output resolution of the printing apparatus 111 are controlled, and a state in which all the pixels per unit area are ON is treated as a state in which a printing amount of the ink is 100%. Note that, “ON” indicates that the ink is ejected, and “OFF” indicates that the ink is not ejected. In a printer in which the ink ejection is under the binary control as described above, the printing amount of the ink for a single pixel can be only expressed as 100% or 0%. Therefore, halftone is expressed by aggregation of multiple pixels.

In an example illustrated in FIG. 4, instead of performing halftone expression at a density of 25% as in the lower left of FIG. 4, the ink is ejected by setting four pixels that are black pixels within 16 pixels (4×4 pixels) to ON as the lower right in FIG. 4, and 25% ( 4/16) of the area is thus expressed. It is possible to achieve the expression in other tones in a similar manner. Note that, the total pixel number for the halftone expression or a pattern and the like of the ON pixels is not limited to the example in FIG. 4. It is possible to determine the pattern of the ON pixels by using cyclic screen processing called halftone dot or error diffusion processing. Note that, the present embodiment is also applicable to a printing head that can modulate an ink ejection amount by expanding the above-described binarization processing to multi-value processing for multiple levels that can be modulated, and it is not limited to binarization.

### [Ink Configuration]

Components forming each of the fluorescent ink, the subtractive color mixture ink, and the clear ink used in the printing apparatus 111 of the present embodiment are described.

### (Aqueous Medium)

It is preferable to use an aqueous medium containing water and a water-soluble organic solvent as the ink used in the present embodiment. A content (% by mass) of the water-soluble organic solvent in the ink is preferably 3.0% by mass or greater and 50.0% by mass or smaller based on the total mass of the ink. Additionally, a content (% by mass) of the water in the ink is preferably 50.0% by mass or greater and 95.0% by mass or smaller based on the total mass of the ink.

Specifically, it is possible to use the followings as the water-soluble organic solvent, for example. It is preferable to use alkyl alcohols with one to six carbons such as methanol, ethanol, propanol, propanediol, butanol, butanediol, pentanol, pentanediol, hexanol, and hexanediol; amides such as dimethylformamide and dimethylacetamide; ketones or keto alcohols such as acetone and diacetone alcohol; ethers such as tetrahydrofuran and dioxane; polyalkylene glycols with an average molecular weight of 200, 300, 400, 600, 1,000, and the like such as polyethylene glycol and polypropylene glycol; alkylene glycols having an alkylene group with two to six carbons such as ethylene glycol, propylene glycol, butylene glycol, triethylene glycol, 1,2,6-hexanetriol, thiodiglycol, hexylene glycol and diethylene glycol; lower alkyl ether acetate such as polyethylene glycol monomethyl ether acetate; glycerin; lower alkyl ethers of polyalcohol such as ethylene glycol monomethyl (or ethyl) ether, diethylene glycol methyl (or ethyl) ether, and triethylene glycol monomethyl (or ethyl) ether; and N-methyl-2-pyrrolidone, 2-pyrrolidone, 1,3-dimethyl-2-imidazolidinone, and the like. Additionally, as the water, it is preferable to use deionized water (ion-exchange water).

### (Pigment)

It is preferable to use carbon black and an organic pigment as a pigment. A content (% by mass) of the pigment in the ink is preferably 0.1% by mass or greater and 15.0% by mass or smaller based on the total mass of the ink.

As the black ink, it is preferable to use the carbon black such as furnace black, lamp black, acetylene black, and channel black as the pigment. Specifically, for example, it is possible to use the following commercialized product and the like: Raven 7000, 5750, 5250, 5000, ULTRA 3500, 2000, 1500, 1250, 1200, 1190, ULTRA-II 1170, and 1255 (manufactured by Columbian Chemicals Company); BLACK PEARLS L, REGAL 330R, 400R, and 660R, MOGUL L, MONARCH 700, 800, 880, 900, 1000, 1100, 1300, 1400, and 2000, and VULCAN XC-72R (manufactured by Cabot Corporation); COLOUR BLACK FW1, FW2, FW2V, FW18, FW200, S150, S160, and S170, PRINTEX 35, U, V, 140U, and 140V, SPECIAL BLACK 6, 5, 4A, and 4 (manufactured by Evonik Degussa GmbH); and No. 25, No. 33, No. 40, No. 47, No. 52, No. 900, No. 2300, MCF-88, MA600, MA7, MA8, and MA100 (manufactured by Mitsubishi Chemical Corporation). Additionally, it is also possible to use carbon black newly prepared for the present embodiment. As a matter of course, in the present embodiment, it is not limited to the above, and any conventional carbon black can be used. Moreover, it is not limited to the carbon black, and magnetic fine particles such as magnetite and ferrite, titanium black, and the like may be used as the pigment.

Specifically, it is possible to use the followings as the organic pigment, for example. It is possible to use: a water-insoluble azo pigment such as toluidine red, toluidine maroon, hansa yellow, benzidine yellow, and pyrazolone red; a water-soluble azo pigment such as lithol red, helio bordeaux, pigment scarlet, and permanent red 2B; a derivative from a vat dyestuff such as alizarin, indanthrone, and thioindigo maroon; a pigment of phthalocyanine family such as phthalocyanine blue and phthalocyanine green; a pigment of quinacridone family such as quinacridone red and quinacridone magenta; a pigment of perylene family such as perylene red and perylene scarlet; a pigment of isoindolinone family such as isoindolinone yellow and isoindolinone orange; a pigment of imidazolone family such as benzimidazolone yellow benzimidazolone orange and benzimidazolone red; a pigment of pyranthrone family such as pyranthrone red and pyranthrone orange; a pigment of indigo family, a pigment of condensed azo family, a pigment of thioindigo family, and a pigment of diketopyrrolopyrrole family; and flavanthrone yellow, acylamide yellow, quinophthalone yellow, nickel azo yellow, copper azomethine yellow, perinone orange, anthrone orange, dianthraquinonyl red, dioxazine violet, and the like. As a matter of course, the present embodiment is not limited to the above.

Additionally, with the organic pigment indicated by a color index (C.I.) number, it is possible to use the followings, for example. It is possible to use: C.I. pigment yellow 12, 13, 14, 17, 20, 24, 74, 83, 86, 93, 97, 109, 110, 117, 120, 125, 128, 137, and additionally, 138, 147, 148, 150, 151, 153, 154, 166, 168, 180, 185, and the like; C.I. pigment orange 16, 36, 43, 51, 55, 59, 61, 71, and the like; C.I. pigment red 9, 48, 49, 52, 53, 57, 97, 122, 123, 149, 168, 175, 176, 177, 180, 192, and the like, and likewise, 215, 216, 217, 220, 223, 224, 226, 227, 228, 238, 240, 254, 255, 272, and the like; C.I. pigment violet 19, 23, 29, 30, 37, 40, 50, and the like; C.I. pigment blue 15, 15:1, 15:3, 15:4, 15:6, 22, 60, 64, and the like; C.I. pigment green 7, 36, and the like; and C.I. pigment brown 23, 25, 26, and the like. As a matter of course, the present embodiment is not limited to the above.

### (Fluorescent Dispersion)

Fluorescent dispersion is dispersion having the fluorescent characteristics. For example, the fluorescent dispersion may include NKW-3207E (fluorescent pink water dispersion: Japan Fluorescence Chemical Co., Ltd.), NKW-3205E (fluorescent yellow water dispersion: Japan Fluorescence Chemical Co., Ltd.), and the like; however, any dispersion having the fluorescent characteristics may be applied.

### (Dispersant)

As long as it is resin having water solubility, it is possible to use any dispersant to disperse the above-mentioned pigment into an aqueous medium. Among them, a dispersant with a weight average molecular weight of 1,000 or greater and 100,000 or smaller, or 3,000 or greater and 15,000 or smaller is preferable. The content (% by mass) of the dispersant in the ink is preferable to be 0.1% by mass or greater and 5.0% by mass or smaller based on the total mass of the ink.

Specifically, it is possible to use the followings as the dispersant, for example. It is possible to use a polymer with a monomer of styrene, vinylnaphthalene, aliphatic alcohol ester of α,β-ethylenically unsaturated carboxylic acid, acrylic acid, maleic acid, itaconic acid, fumaric acid, vinyl acetate, vinylpyrrolidone, acrylamide, or a derivative of the above and the like. Note that, one or more of the monomers forming the polymer are preferably a hydrophilic monomer, and a block copolymer, a random copolymer, a graft copolymer, a salt of the above, or the like may be used. Alternatively, native resin such as rosin, shellac, and starch may also be used. The above types of resin are preferably soluble in a solution in which a base is dissolved, that is, the above types of resin are preferably an alkaline soluble type.

### (Surfactant)

In order to adjust surface tension of the ink forming an ink set, it is preferable to use a surfactant such as an anionic surfactant, a nonionic surfactant, and an amphoteric surfactant. Specifically, it is possible to use polyoxyethylene alkyl ether, polyoxyethylene alkyl phenols, acetylene glycol compound, acetylene glycol ethylene oxide adduct, and the like.

### (Other Components)

In order to maintain the moisture, the ink forming the ink set may contain a moisture solid content such as urea, a urea derivative, trimethylol propane, and trimethylol ethane in addition to the above-described components. A content (% by mass) of the moisture solid content in the ink is preferably 0.1% by mass or greater and 20.0% by mass or smaller, or 3.0% by mass or greater and 10.0% by mass or smaller based on the total mass of the ink. Additionally, in addition to the above-described components, the ink forming the ink set may contain various additive agents such as a pH adjuster, an antirust agent, an antiseptic agent, an antifungal agent, an antioxidant, a reducing inhibitor, and an evaporation promoter as needed.

Next, the ink used in the present embodiment is described more specifically. The present technique is not limited by the present embodiment as long as it does not depart from the gist. Note that, “percent” and “%” in the descriptions are based on mass unless stated otherwise.

### (Preparation of Resin Solution A)

A random copolymer of styrene/acrylic acid with an acid value of 200 mg KOH/g and a weight average molecular weight of 10,000 is neutralized to 1 equivalent by potassium hydroxide. Thereafter, water is used to adjust a resin density to 10.0%; thus, a resin solution A is obtained.

### (Preparation of Resin Solution B)

A random copolymer with monomer composition of styrene/n-butyl acrylate/acrylic acid=23/37/37 with an acid value of 288 mg KOH/g and a weight average molecular weight of 10,000 is neutralized to 1 equivalent by potassium hydroxide. Thereafter, water is used to adjust a resin density to 10.0%; thus, a resin solution B is obtained.

### (Preparation of Resin Solution C)

A random copolymer with monomer composition of styrene/n-butyl acrylate/acrylic acid=23/37/37 with an acid value of 288 mg KOH/g and a weight average molecular weight of 5,000 is neutralized to 1 equivalent by potassium hydroxide. Thereafter, water is used to adjust a resin density to 10.0% by water; thus, a resin solution C is obtained. Since the resin solution C has a smaller molecular weight than that of the resin solution B, the resin solution C has an effect of reducing surface irregularities and a clearance during printing and increasing a refractive index in appearance. Note that, other than the molecular weight, a method of improving the spreadability of the ink by adding 1, 2 hexanediol may also be considered as a method of improving the leveling property of the ink.

### (Preparation of Pigment Dispersion Liquids 1 to 4)

Pigment dispersion liquids 1 to 4 are prepared according to the procedures described below.

### “Preparation of Pigment Dispersion Liquid 1 Including C.I. Pigment Red 122”

Mixing is performed with 10 percent of the pigment (C.I. pigment red 122), 20 percent of the resin solution A, and 70 percent of ion-exchange water, and the mixture is dispersed for three hours by using a batch type vertical sand mill. Thereafter, a coarse particle is removed by centrifugation processing. In addition, pressure filtration is performed by a cellulose acetate filter with a pore size of 3.0 μm (manufactured by ADVANTEC CO., LTD.); thus, a pigment dispersion liquid 1 with a pigment density of 10% by mass is obtained.

### “Preparation of Pigment Dispersion Liquid 2 Including C.I. Pigment Blue 15:3”

Mixing is performed with 10 percent of the pigment (C.I. pigment blue 15:3), 20 percent of the resin solution A, and 70 percent of the ion-exchange water, and the mixture is dispersed for five hours by using the batch type vertical sand mill. Thereafter, the coarse particle is removed by the centrifugation processing. In addition, the pressure filtration is performed by the cellulose acetate filter with a pore size of 3.0 μm (manufactured by ADVANTEC CO., LTD.); thus, a pigment dispersion liquid 2 with a pigment density of 10% by mass is obtained.

### “Preparation of Pigment Dispersion Liquid 3 Including C.I. Pigment Yellow 74”

Mixing is performed with 10 percent of the pigment (C.I. pigment yellow 74), 20 percent of the resin solution A, and 70 percent of the ion-exchange water, and the mixture is dispersed for one hour by using the batch type vertical sand mill. Thereafter, the coarse particle is removed by the centrifugation processing. In addition, the pressure filtration is performed by the cellulose acetate filter with a pore size of 3.0 μm (manufactured by ADVANTEC CO., LTD.); thus, a pigment dispersion liquid 3 with a pigment density of 10% by mass is obtained.

### “Preparation of Pigment Dispersion Liquid 4 Including C.I. Pigment Black 7”

Mixing is performed with 10 percent of a carbon black pigment (C.I. pigment black 7), 20 percent of the resin solution A, and 70 percent of the ion-exchange water, and the mixture is dispersed for three hours by using the batch type vertical sand mill. Note that, a peripheral speed during the dispersion is twice the peripheral speed in a case of preparing the pigment dispersion liquid 1. Thereafter, the coarse particle is removed by the centrifugation processing. In addition, the pressure filtration is performed by the cellulose acetate filter with a pore size of 3.0 μm (manufactured by ADVANTEC CO., LTD.); thus, a pigment dispersion liquid 4 with a pigment density of 10% by mass is obtained.

### (Preparation of Fluorescent Dispersion Liquid)

Mixing is performed with 10 percent of a fluorescent pink water dispersion (NKW-3207E), 20 percent of the resin solution A, and 70 percent of the ion-exchange water, and the mixture is dispersed by using a homo mixer and the like. In addition, the pressure filtration is performed by the cellulose acetate filter with a pore size of 3.0 μm (manufactured by ADVANTEC CO., LTD.); thus, a fluorescent dispersion liquid with a fluorescent dispersion density of 10% by mass is obtained.

### (Preparation of Ink)

The components indicated in Table 1 are mixed and agitated sufficiently.

Thereafter, the pressure filtration is performed by the cellulose acetate filter with a pore size of 0.8 μm (manufactured by ADVANTEC CO., LTD.); thus, the subtractive color mixture inks CMYK, the fluorescent ink (P), the first clear ink (CL1), and the second clear ink (CL2) are prepared.

TABLE 1

| | M | C | Y | K | P | CL1 | CL2 |
|---|---|---|---|---|---|---|---|
| pigment dispersion | 40 | | | | | | |
| liquid 1 | | | | | | | |
| pigment dispersion | | 40 | | | | | |
| liquid 2 | | | | | | | |
| pigment dispersion | | | 40 | | | | |
| liquid 3 | | | | | | | |
| pigment dispersion | | | | 30 | | | |
| liquid 4 | | | | | | | |
| fluorescent | | | | | 40 | | |
| dispersion liquid | | | | | | | |
| resin solution C | | | | | | 1 | |
| resin solution B | | | | | | | 3 |
| glycerin | 5.0 | 5.0 | 5.0 | 5.0 | 5.0 | 5.0 | 5.0 |
| diethylene glycol | 5.0 | 5.0 | 5.0 | 5.0 | 5.0 | 5.0 | 5.0 |
| polyethylene | 5.0 | 5.0 | 5.0 | 5.0 | 5.0 | 5.0 | 5.0 |
| glycol 1000 | | | | | | | |
| SURFYNOL 465 | 1.0 | 1.0 | 1.0 | 1.0 | 1.0 | 1.0 | 1.0 |
| ion-exchange water | 44 | 44 | 44 | 54 | 44 | 83 | 81 |

Note that, the composition of the first clear ink (CL1) and the second clear ink (CL2) is not limited to the above. As long as it is an ink configured to control the later-described deviation angle characteristics and can obtain a similar effect, a different type of resin and a different resin adding amount may be applied.

### [About Characteristics of Fluorescent Ink and Subtractive Color Mixture Ink]

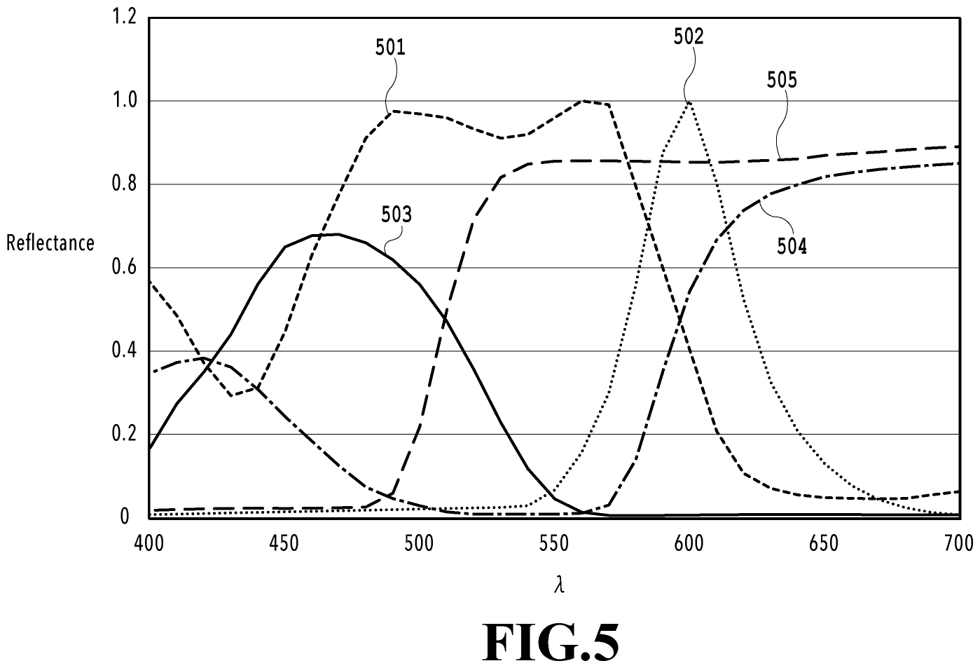

FIG. 5 is a graph in which a horizontal axis indicates a wavelength of light while a vertical axis indicates a reflectance (intensity), and indicates the intensity of the light in a case where the wavelength of the light irradiating a printing sample and the wavelength of the light received from the sample are changed and detected, respectively.

A fluorescent component included in the fluorescent ink is a color material that develops the color by absorbing the light of an excitation wavelength in the ground state to transition to the excited state and emitting light of a light-emission wavelength to return to the ground state. The fluorescent pink ink that the printing head of the above-described printing apparatus 111 can eject is the fluorescent ink using the above-described fluorescent component.

Light emission 502 indicates the intensity of the light at each wavelength that is received from the printing sample in a case where the printing sample on which the fluorescent pink ink of the present embodiment is printed on a paper surface is irradiated with the light at an excitation wavelength of 480 nm.

Excitation 501 indicates the intensity of received light with respect to the wavelength of the light irradiating the printing sample on which the fluorescent pink ink of the present embodiment is printed while fixing the wavelength of the received light to 600 nm.

As illustrated in FIG. 5, a wavelength range in which the fluorescent ink printed on the paper surface is excited is on a short wavelength side while overlapping with a wavelength range of the light emission. Additionally, it is indicated that the excitation 501 is varied in the intensity for each wavelength and has a wavelength with efficient light emission and a wavelength with inefficient light emission. Moreover, since the fluorescent ink emits light, the reflectance in the light-emission wavelength may exceed 1. In the present embodiment, a component that has the above-described characteristics is defined as the fluorescent component.

As the characteristics of the fluorescent ink, the excitation and the light emission of the fluorescent pink ink employed to the printing apparatus 111 of the present embodiment are described; however, a fluorescent ink that emits light at another wavelength may be employed to the printing apparatus 111 of the present embodiment. Such a fluorescent ink may include, for example, fluorescent inks of fluorescent blue that emits light of a blue region (450 nm to 500 nm) and fluorescent green that emits light of a green region (500 nm to 565 nm). Additionally, fluorescent inks of fluorescent yellow that emits light of a yellow region (565 nm to 590 nm), fluorescent orange or fluorescent red that emits light of a red region (590 nm to 780 nm), and the like may be employed. In addition, a fluorescent ink that is a combination of the above-described fluorescent inks may be employed. Moreover, a fluorescent ink with an adjusted color tone that is obtained by combining fluorescent inks with different intensities of excitation wavelength may be employed. The fluorescent ink with the adjusted color tone may include, for example, fluorescent pink with weak excitation in the blue region, strong excitation in the green region, and light emission in the orange region.

In the present embodiment, the subtractive color mixture ink (also referred to as a “color ink”) is defined as an ink that contains a color material that absorbs light of a specific wavelength out of the light irradiated with and does not emit light. For example, a spectral reflectance of the subtractive color mixture ink is the spectral reflectance of cyan (C) 503, magenta (M) 504, and yellow (Y) 505 in FIG. 5. Unlike the fluorescent ink, the subtractive color mixture ink only absorbs the light; for this reason, the reflectance does not exceed 1.

### [About Deviation Angle Characteristics of Fluorescent Ink and Subtractive Color Mixture Ink]

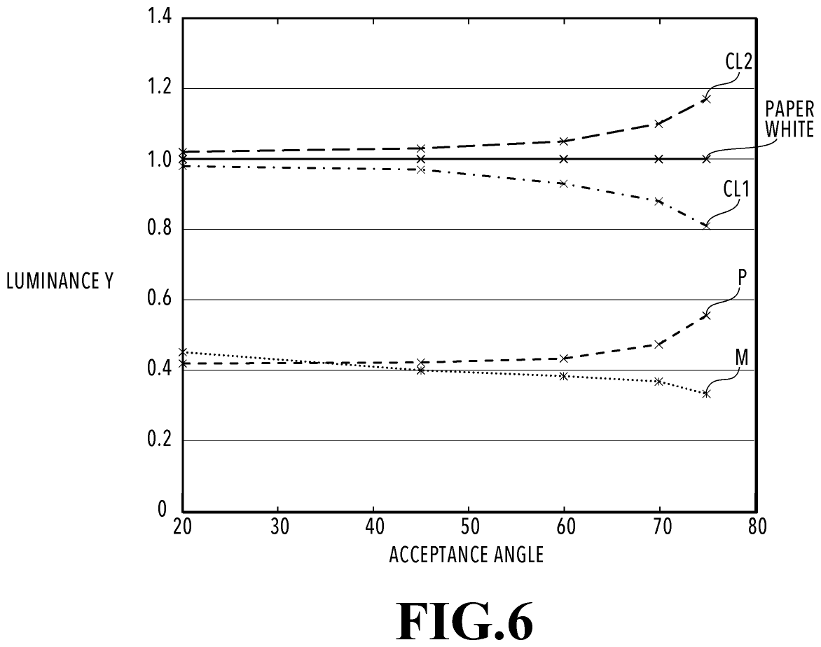

FIG. 6 is a graph indicating the deviation angle characteristics of the inks including the fluorescent ink (P) and the color ink (M) that is the subtractive color mixture ink. A curved line in the graph of FIG. 6 indicates the reflectance measured by emitting light to enter the printing sample at an incident angle of 0° and changing an acceptance angle. It is possible to measure the reflectance by using a spectrophotometer (V-770) manufactured by JASCO Corporation, for example. In the graph, a horizontal axis indicates the acceptance angle during the measurement while a vertical axis indicates the reflectance in a case where paper white is 1.0.

As indicated by the graph in FIG. 6, it is indicated that as the acceptance angle during the measurement of the printing sample is increased, the reflectance of the fluorescent ink (P) is increased, and the reflectance of the color ink (M) is decreased. A greater acceptance angle during the measurement corresponds to a fact that the printing sample is observed more obliquely. The graph in FIG. 6 indicates that, in a case of more oblique observation, the fluorescent ink (P) appears brighter, and the color ink (M) appears darker.

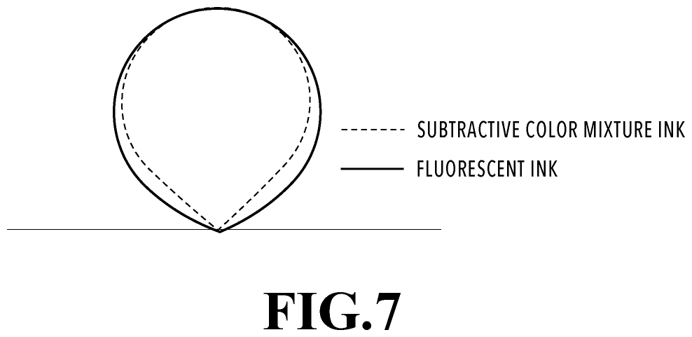

FIG. 7 schematically illustrates the deviation angle characteristics illustrated in FIG. 6. A solid line indicates the fluorescent ink while a broken line indicates the subtractive color mixture ink. With the deviation angle characteristics of the fluorescent ink, the light scatters isotropically more than the light with the deviation angle characteristics of the subtractive color mixture ink. It can be considered that this is because, since the fluorescent ink absorbs the light to be excited and emits light, the directionality of the incident light is lost, and the light strongly depends on the directionality of the light emission of the fluorescent ink. Such a difference in the deviation angle characteristics is modeled by the bidirectional reflectance distribution function and the like and can also be measured by a commercially available BRDF measurement apparatus.

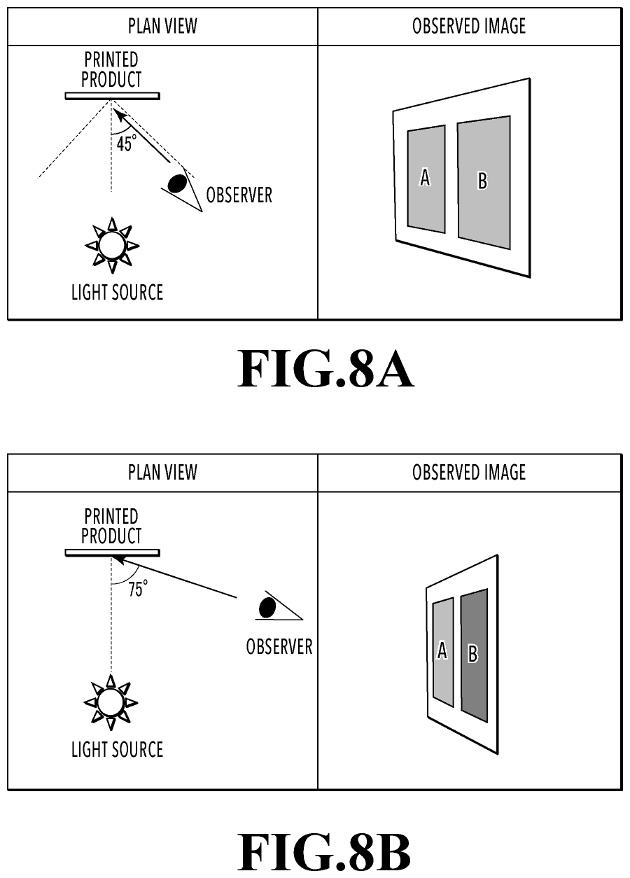

FIGS. 8A and 8B are diagrams describing an example of an image defect due to the above-described difference in the deviation angle characteristics. FIGS. 8A and 8B each include a plan view illustrating a positional relationship between a printed product, a light source that enters the printed product at the incident angle of 0°, and an observer observing the printed product, and an observed image indicating how the printed product looks in the observation under each condition. FIG. 8A is a diagram illustrating the plan view and the observed image in a case where the observer observes the printed product at the acceptance angle of 45°. FIG. 8B is a diagram illustrating the plan view and the observed image in a case where the observer observes the printed product at the acceptance angle of 75°. In the observed images in FIGS. 8A and 8B, a surface A indicates a region printed with the fluorescent ink, and a surface B indicates a region printed with the color ink that is the subtractive color mixture ink.

The observed image in FIG. 8A indicates how the printed product looks in a case of the observation from substantially the front, and it is indicated that the surface A and the surface B are observed at substantially the same brightness. Thus, in a case of the observation in a normal environment, the printed product is observed as an image with no defect assumed by a maker of the printed product.

On the other hand, as indicated by the observed image in FIG. 8B, in a case where the observer looks at the printed product obliquely, the surface B printed with the color ink appears darker than the surface A printed with the fluorescent ink. This is because, since the deviation angle characteristics between the fluorescent ink (P) and the color ink (M) are different as illustrated by FIG. 6, the fluorescent ink (P) appears relatively bright as an observation angle is increased. Thus, in a case where the deviation angle characteristics of the inks are different from each other, in some cases, the image looks as if there is a defect not intended by the maker such as unbalanced gradation and colors in the image depending on the observation angle.

For the printed product observed by an unspecified number of people, such as posters for advertising purposes, there is a demand to reduce observation conditions that prevent the presentation of the image intended by the creator. That is, in some cases, there is a demand to print the image so as to prevent the unbalanced gradation and colors in the image even in a case of the oblique observation. Under the circumstances, in the present embodiment, a method of suppressing the difference in the deviation angle characteristics between the printing region of the fluorescent ink and the printing region of the color ink by using the two clear inks having different deviation angle characteristics is described.

### [Control of Deviation Angle Characteristics by Clear Ink]

The deviation angle characteristics of the first clear ink (CL1) and the second clear ink (CL2) used in the present embodiment are described. CL1 in the graph in FIG. 6 indicates the deviation angle characteristics of the first clear ink, and CL2 indicates the deviation angle characteristics of the second clear ink.

The first clear ink (CL1) is an ink with a high refractive index. Thinking of a behavior of the light that passes through an ink layer and advances to an air layer, an incident angle and an emission angle (a refraction angle) are changed according to a ratio of the refractive indexes between the ink and the air. This behavior is known as the Snell's law. As the refractive index of the ink is higher, a critical angle, which is an angle at which emission from the ink layer to the air layer is allowed, is narrower; therefore, it can be considered that the light emitted in an oblique direction (a direction in which the acceptance angle is greater in FIG. 6) is reduced (hereinafter, this state is also referred to as “the isotropy is small”). In contrast, the second clear ink (CL2) has the refractive index relatively lower than that of the other inks. Therefore, the light emitted in the oblique direction is relatively increased (hereinafter, this state is also referred to as “the isotropy is great”).

It is possible to express the isotropy by a value of a ratio of feature amounts indicating the brightness at different two observation angles. For example, luminance in a case where the incident angle of the light source is 0° while the acceptance angle during the observation is 75° (the incident angle of 0° and the acceptance angle of) 75° is Y₀₋₇₅. Additionally, luminance in a case where the incident angle of the light source is 0° while the acceptance angle during the observation is 45° (the incident angle of 0° and the acceptance angle of 45°) is Y₀₋₄₅. The unit of luminance is [cd/m²], for example. Thus, it is possible to evaluate the degree of the isotropy based on a ratio R obtained by R=Y₀₋₇₅/Y₀₋₄₅.

In a case where the ratio R is great, this indicates that there is a great amount of the light emitted in the oblique direction, and the isotropy is accordingly great. In a case where the ratio R is small, this indicates that there is a small amount of the light emitted in the oblique direction, and the isotropy is accordingly small. Note that, in addition to the luminance, the degree of the isotropy may be expressed by using another feature amount such as lightness and density taking into consideration the visual sensitivity of humans.

In the present embodiment, the luminance with the incident angle of 0° and the acceptance angle of 75° and the luminance with the incident angle of 0° and the acceptance angle of 45° are measured, and the ratio R thereof is used as a numerical value evaluating the degree of the isotropy. It is also possible to evaluate the degree of the isotropy by using other incident angle and acceptance angle.

Additionally, a cause other than the refractive index that affects the deviation angle characteristics may include irregularities of an ink layer surface. In a case where the surface is flat and smooth, a behavior of the light that is close to an ideal interface is obtained, and the emission angle is limited by an effect of the above-described critical angle and the like. That is, the isotropy is relatively small. On the other hand, in a case where the surface is rough, it means that surface normals face in different directions in terms of a micro surface. Therefore, there is less effect of the critical angle, and macroscopically, the light appears diffused. That is, there is a relatively great amount of the light emitted in the oblique direction, and the isotropy is great.

With the above-described characteristics, it is possible to control the degree of the isotropy of the region printed with the color ink or the fluorescent ink by using the color ink or the fluorescent ink and the clear inks having different deviation angle characteristics. For example, it is possible to reduce the light emitted in the oblique direction by overcoating the first clear ink (CL1) on the fluorescent ink printing region printed with the fluorescent ink (P) illustrated in FIG. 6. Additionally, it is also possible to control the increase and reduction of the light by coating with the clear ink probabilistically by using area gradation. Thus, for example, it is possible to control the degree of the isotropy of the fluorescent ink printing region to be substantially equal to the degree of the isotropy of the color ink printing region that is the region printed with the color ink (M).

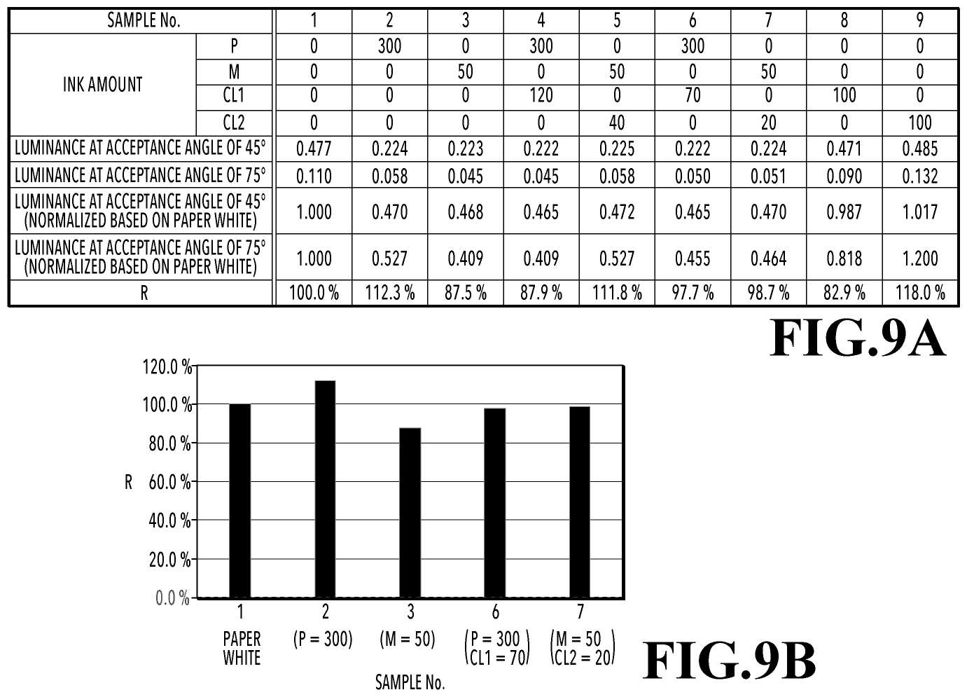

FIGS. 9A and 9B are diagrams illustrating a measurement result of the sample obtained by the printing apparatus 111 of the present embodiment. Samples No. 1 to No. 9 are each obtained by filling an ink cartridge with each ink in the Table 1 and performing printing by an ink jet printing apparatus in which a printing head that ejects the ink by thermal energy is mounted. A product name “PIXUS PRO-10S” manufactured by Canon Inc. is used as the ink jet printing apparatus. The image printed by this ink jet printing apparatus under the conditions that four droplets of the ink of 3.8 ng+10% is applied to a unit region of 1/600 inches×1/600 inches is defined to have a printing duty of 100%. A product name “Canon Photo Paper Pro Premium Matte PM101” manufactured by Canon Inc. is used as the printing medium.

FIG. 9A is a table gathering an ink amount, the luminance at the incident angle of 0° and the acceptance angle of 75°, the luminance at the incident angle of 0° and the acceptance angle of 45°, normalized luminance at each of the acceptance angles of 75° and 45°, and the ratio R of each sample. The ratio R is the value calculated by using the normalized luminance at the incident angle of 0° and the acceptance angle of 75° as a numerator and the normalized luminance at the incident angle of 0° and the acceptance angle of 45° as a denominator. The normalized luminance is a value of the luminance in a case where the luminance observed at the same acceptance angle in a case of the paper white (the sample No. 1) is 1.000.

A numerical value indicated as the ink amount in FIG. 9A is the above-described printing duty equivalent value [%]. As for the ink amount, there is a sample in which the ink amount of the fluorescent ink (P) or the color ink (M) and the first clear ink (CL1) or the second clear ink (CL2) is greater than 0. This sample indicates that the sample is generated by performing printing by overcoating the first clear ink (CL1) or the second clear ink (CL2) on the region printed with the fluorescent ink (P) or the color ink (M).

The luminance in a case where the light source enters at the incident angle of 0° and the light is received at the acceptance angle of 75° (the incident angle of 0° and the acceptance angle of) 75° and the luminance in a case where the light source enters at the incident angle of 0° and the light is received at the acceptance angle of 45° (the incident angle of 0° and the acceptance angle of) 45° are values measured by the spectrophotometer V-770 manufactured by JASCO Corporation. This measured luminance is a value in a case where the luminance in a case of measurement in which the light source enters at the incident angle of 0° and the acceptance angle is 180°, that is, the luminance in a case of measuring the incidence light itself, is 1.0. The ratio R is the evaluation value indicating the degree of the isotropy of the deviation angle characteristics. In a case where the ratio R is great, it means that there is a great amount of the light emitted in the oblique direction, and the isotropy is great. In a case where the ratio R is small, it means that there is a small amount of the light emitted in the oblique direction, and the isotropy is small.

FIG. 9B is a bar graph illustrating values of the ratio R of the samples No. 1, No. 2, No. 3, No. 6, and No. 7 indicated in FIG. 9A.

The sample No. 2 is a sample of printing with only the fluorescent ink (P), and the sample No. 3 is a sample of printing with only the color ink (M), which are samples of printing in a without-clear-ink mode described later. As illustrated in FIG. 9B, it is indicated that a difference in the ratio R between the sample No. 2 and the sample No. 3 is great, and a difference in the degree of the isotropy between the fluorescent ink (P) and the color ink (M) is great. In comparison between the values of the samples No. 2 and No. 3 indicated in FIG. 9A, the luminances at the acceptance angle of 45° are substantially the same, but there is a difference in the luminances at the acceptance angle of 75°; this causes a great difference in the ratio R.

The sample No. 6 is a sample obtained by printing in a with-clear-ink mode, which is a sample obtained by overcoating the region printed with the fluorescent ink (P) with the first clear ink (CL1) of the ink amount of 70. The ratio R of the sample No. 6 has a smaller value than that of the ratio R of the sample No. 2 printed with only the fluorescent ink (P) and is closer to the ratio R of the paper white. That is, it is indicated that the isotropy is reduced by the overcoating with the first clear ink (CL1) and is closer to the degree of the isotropy of the paper white.

The sample No. 7 is a sample obtained by printing in the with-clear-ink mode, which is a sample obtained by overcoating the region printed with the color ink with the second clear ink (CL2) of the ink amount of 20. In the sample No. 7, the value of the ratio R is greater than that of the sample No. 3 printed with only the color ink and is closer to the ratio R of the paper white. That is, it is indicated that the isotropy is increased by the overcoating with the second clear ink (CL2) and is closer to the degree of the isotropy of the paper white.

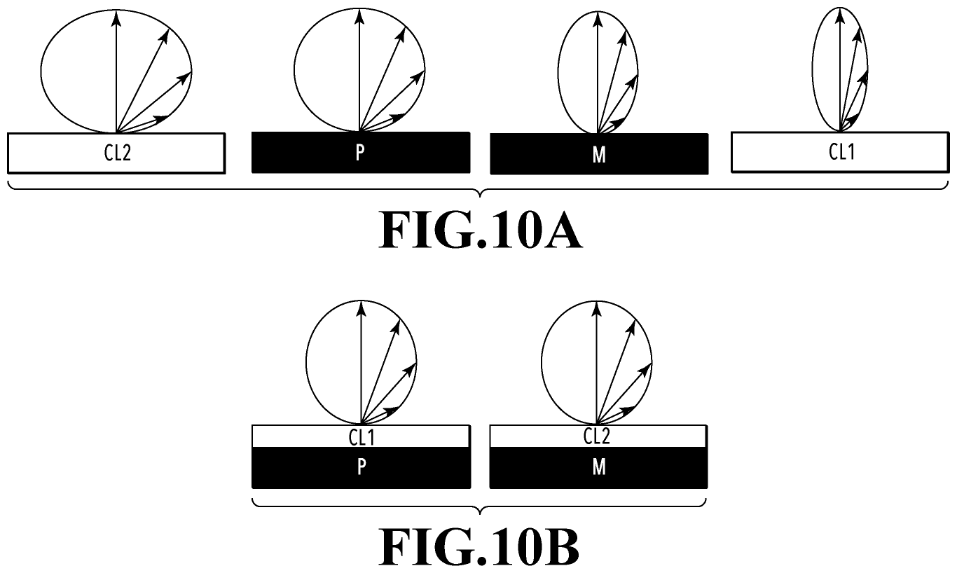

FIGS. 10A and 10B are schematic views illustrating the deviation angle characteristics of the inks, which are the color ink, the fluorescent ink, the first clear ink, and the second clear ink, or the deviation angle characteristics of a combination of the inks. In FIGS. 10A and 10B, a length of an arrow indicates the degree of brightness of reflected light. Between the color ink, the fluorescent ink, and the clear inks, the reflectance, that is, the luminance at the incident angle of 0° and the acceptance angle of 0° are greatly different from each other. However, it should be noted that the expression is normalized since FIGS. 10A and 10B are for description of the change in the deviation angle characteristics due to the change in the observation angle for each ink type. That is, the reason that arrows in a perpendicular direction have the same length in FIG. 10A is that it is illustrated under the assumption that printing is performed with the inks at the same lightness for comparison.

FIG. 10A illustrates the deviation angle characteristics of each single ink, and since the degree of the isotropy is different depending on the ink, the sizes of arrows in oblique directions are different from each other depending on the ink type. In FIG. 10A, it is indicated that the second clear ink (CL2)>the fluorescent ink (P)>the color ink (M)>the first clear ink (CL1) in descending order of the degree of the isotropy. Note that, the degrees of the isotropy of the color inks C, M, Y, and K are substantially the same. It is possible to figure out the deviation angle characteristics by measuring the samples obtained by the printing on the printing medium in advance with the inks at multiple acceptance angles as described above. FIG. 10B is described later.

### [Functional Configuration of Image Processing Apparatus]

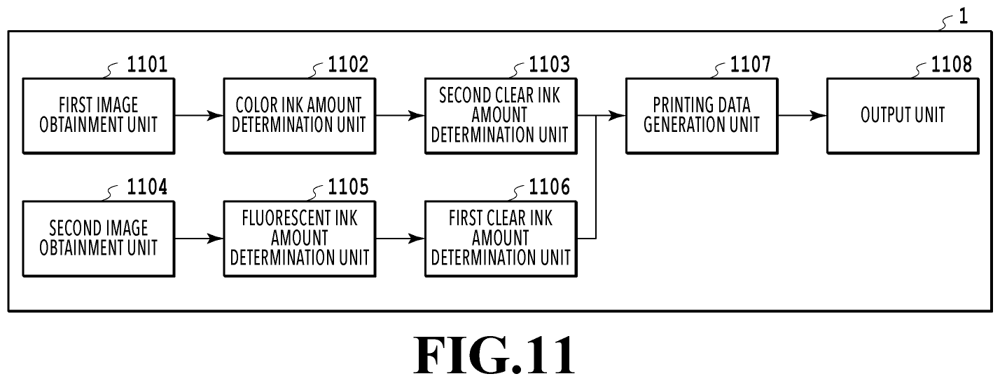

FIG. 11 is a diagram illustrating a functional configuration of the image processing apparatus 1 in the present embodiment. The image processing apparatus 1 includes a first image obtainment unit 1101, a color ink amount determination unit 1102, a second clear ink amount determination unit 1103, a second image obtainment unit 1104, a fluorescent ink amount determination unit 1105, a first clear ink amount determination unit 1106, and a printing data generation unit 1107. In addition, the image processing apparatus 1 includes an output unit 1108.

The first image obtainment unit 1101 obtains first image data in which a signal value corresponding to the color ink is a pixel value. The second image obtainment unit 1104 obtains second image data in which a signal value of a color for the fluorescent ink that is used as a special color or a spot color is the pixel value. The color ink amount determination unit 1102 determines the color ink amount in each pixel from the first image data. The fluorescent ink amount determination unit 1105 determines the fluorescent ink amount in each pixel from the second image data. The second clear ink amount determination unit 1103 determines the ink amount of the second clear ink in each pixel. The first clear ink amount determination unit 1106 determines the ink amount of the first clear ink in each pixel.

The printing data generation unit 1107 performs binarization processing on data of the determined color ink amount, fluorescent ink amount, ink amount of the first clear ink, and ink amount of the second clear ink. Then, the printing data generation unit 1107 generates printing data indicating ON and OFF of each ink in each pixel. The output unit 1108 outputs the printing data to the printing apparatus 111. The printing apparatus 111 prints the image based on the printing data.

Each functional unit in the image processing apparatus 1 in FIG. 11 is implemented with the CPU 101 executing a predetermined program; however, it is not limited thereto. In addition, for example, hardware such as a graphics processing unit (GPU) to speed up computation or a field programmable gate array (FPGA) may be used. Each functional unit may be implemented by cooperation between software and the hardware such as a dedicated IC, or a part of or all the functions may be implemented by only the hardware.

### [Processing Flow]

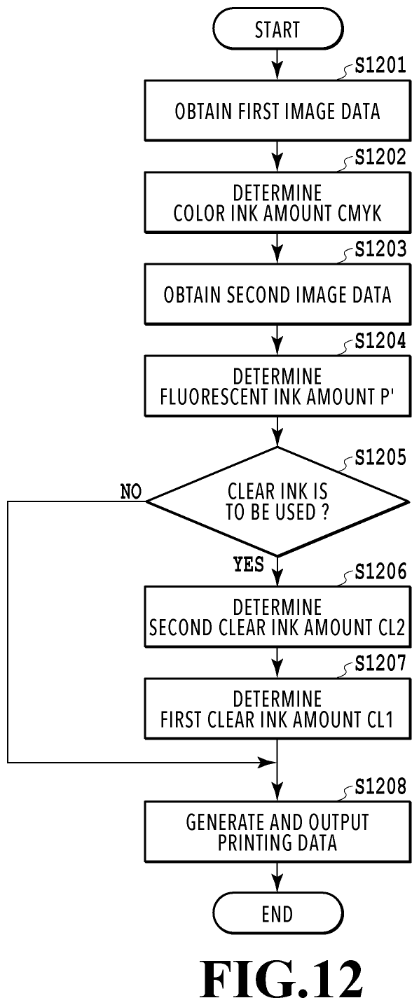

FIG. 12 is a flowchart illustrating a flow of processing in the present embodiment in which the image processing apparatus 1 outputs the printing data that is the data for the printing apparatus 111 to perform image printing. The processing in each step in FIG. 12 is performed with the CPU 101 of the image processing apparatus 1 deploying the program code stored in the ROM 102 to the RAM 103 to execute. Alternatively, a part of or all the functions of the steps in FIG. 12 may be implemented by hardware such as an ASIC or an electronic circuit. A sign “S” in each description of the processing means that it is a step in the flowchart.

The image processing apparatus 1 stores the data of the image as a printing target to perform the printing by the printing apparatus 111. The data of the image as the printing target is, for example, data obtained by designing graphics using special color pink as the spot color by using an image generation application. A layer of the special color pink is designed by using a layer different from an RGB layer. The data of the image as the printing target is generated as separated layers to generate first image data that is data of an RGB image and second image data for the fluorescent ink (P).

Additionally, the image generation application has an attribute of overprinting, and in a case where objects are overlapped with each other, whether to print the lower object is controlled. By default, processing to print only the top object without reflecting applying information of the lower object is performed commonly. Additionally, in a case where the image data in which the objects are overlapped with each other is received, it is also possible to set so as not to perform the overprinting by the image processing apparatus 1. In the present embodiment, in the data of the image as the printing target, the printing region printed with the fluorescent ink (P) holds the pixel value of each pixel so as not to perform printing with the color ink CMYK.

In S1201, the first image obtainment unit 1101 obtains the first image data generated from the data of the image as the printing target from an external apparatus such as the HDD 113.

The first image data is the RGB image data having an RGB value that is the pixel value for each pixel. The RGB value is a value of 48-bit in total that is formed of the signal values that are an red (R) value, a green (G) value, and a blue (B) value of 16-bit corresponding to each of the RGB colors. The pixel value in a position (x,y) of the pixel is expressed as RGB (x,y). The position (x,y) indicates the pixel position in the image in a case where a coordinate in a horizontal direction of the pixel is x while a coordinate in a vertical direction of the pixel is y.

It is described that the first image data in the present embodiment is the image data in which the pixel value is the RGB value defined on an sRGB space. In addition, as the first image data, image data such as the RGB image defined by Adobe RGB used commonly, a Lab image corresponding to CIELAB, or an HSV image formed of hue, saturation, and lightness may be used.

In S1202, the color ink amount determination unit 1102 determines a color ink amount CMYK (x,y) that is the ink amount of the color ink CMYK in the position (x,y) from the first image data. For the determination of the color ink amount, it is possible to use a common method such as using a lookup table (LUT) in which RGB and CMYK prepared in advance are associated with each other. Additionally, as preprocessing, color conversion for color management and the like may be performed as needed. It is described that the color ink amount CMYK (x,y) is data formed of the signal values of the corresponding ink colors C, M, Y, and K, and the signal value is a density value with each gradation number of 8-bit (0 to 255). Note that, the value indicating the ink amount is an example and may be expressed by another bit number or percentage.

In S1203, the second image obtainment unit 1104 obtains the second image data generated from the data of the image as the printing target from the external apparatus such as the HDD 113. The second image data is an image for the fluorescent ink used as the special color or the spot color and is an image in which the pixel value in each position (x,y) of the pixel is a P (special color pink) value of 16-bit. In the second image data, the pixel value in the position (x,y) is expressed as P (x,y).

As described above, in the present embodiment, the printing region of the pixel value P and the printing region of the pixel value CMYK are exclusive. That is, in one position (x,y), there is no case of CMYK (x,y)>0 while P (x,y)>0.

In S1204, the fluorescent ink amount determination unit 1105 determines a fluorescent ink amount P′ (x,y) that is the ink amount of the fluorescent ink by performing gamma correction and the like on the pixel value P (x,y) of the second image data. As with CMYK (x,y), the signal value of P′ (x,y) is a density value with each gradation number of 8-bit (0 to 255).

In S1205, the printing data generation unit 1107 determines whether to use the clear ink in printing the image in the printing apparatus 111. If the printing data generation unit 1107 determines that the clear ink is to be used (YES in S1205), the processing proceeds to S1206. If the printing data generation unit 1107 determines that the clear ink is not to be used (NO in S1205), S1206 and S1207 are skipped, and the processing proceeds to S1208.

The printing apparatus 111 of the present embodiment is formed such that either of the “with-clear-ink mode” and the “without-clear-ink mode” is set as a printing mode. The user manually selects either of the “with-clear-ink mode” and the “without-clear-ink mode”, and thus the mode selected by the user is set. In a case where the “with-clear-ink mode” is set, in S1205, it is determined that the clear ink is to be used. In a case where the “without-clear-ink mode” is set, it is determined that the clear ink is not to be used.

Alternatively, whether to use the clear ink may be determined regardless of the selection by the user. For example, the sum of the fluorescent ink amounts P′ (x,y) in all the positions in the image is calculated. In a case where no fluorescent ink is used, a calculation result is zero; thus, it may be determined that the clear ink is not to be used if the sum of the fluorescent ink amounts P′ (x,y) is zero. Additionally, it may be determined that the clear ink is to be used if the sum of the fluorescent ink amounts P′ (x,y) is other than zero.

In S1206, the second clear ink amount determination unit 1103 calculates the ink amount CL2 (x,y) of the second clear ink printed in the position (x,y) by using Expression (1). Descriptions are given assuming that the signal value indicating the ink amount CL2 (x,y) is also a density value of 8-bit (0 to 255).

$$\begin{matrix}if CMYK ( x , y ) > 0 , CL 2 ( x , y ) = a \\ else CL 2 ( x , y ) = 0\end{matrix} \qquad Expression ( 1 )$$

CMYK (x,y)>0 in the Expression (1) indicates that CMYK (x,y)>0 is obtained if the ink amount (the signal value) of any one of the inks C, M, Y, and K is greater than 0. Therefore, printing is performed with the second clear ink in the position (x,y) printed with any one of the color inks C, M, Y, and K, and the ink amount CL2 (x,y) of the second clear ink during printing is determined.

Additionally, a case where the CMYK (x,y)>0 is not obtained in the Expression (1), that is, a case where else in the Expression (1) is obtained is a case where P′ (x,y)>0 is obtained or a case where CMYK (x,y)=0 while P′ (x,y)=0 is obtained. A case where CMYK (x,y)=0 while P′ (x,y)=0 is obtained is a case where the position (x,y) is a position of the paper white in which no printing with the ink is performed.

A value a of the ink amount CL2 (x,y) of the second clear ink in the Expression (1) is a constant set in advance, and the value a may be determined in advance such that the degrees of the isotropy of the color ink and the fluorescent ink are close to each other. For example, as indicated by the measurement result in FIG. 9A, it is indicated that the isotropy of the color ink is close to the paper white in a case where the ink amount of the second clear ink is the printing duty equivalent value of 20%. Therefore, the value a in the Expression (1) may be determined to be a value corresponding to the printing duty equivalent value of 20%. For example, in a case of assuming that the 256 gradations of the signal value and the ink amount have a linear relationship, since the ink amount in FIG. 9A is indicated under the assumption that the ink is ejected by 300% at a maximum, the value a is determined based on 255×(20/300)=17. This numerical value is a value for describing the present embodiment, and since the relationship between the signal value and the printing duty equivalent value is different for each product, the value may be determined in advance depending on the product.

In S1207, the first clear ink amount determination unit 1106 calculates the ink amount CL1 (x,y) of the first clear ink printed in the position (x,y) by using Expression (2). The printing with the first clear ink is performed in the position (x,y) printed with the fluorescent ink, and the ink amount CL1 (x,y) of the first clear ink during printing is determined. The signal value indicating the ink amount CL1 (x,y) of the first clear ink is also a density value of 8-bit (0 to 255).

$$\begin{matrix}if {P}^{′} ( x , y ) > 0 , CL 1 ( x , y ) = b \\ else CL 1 ( x , y ) = 0\end{matrix} \qquad Expression ( 2 )$$

A case where P′ (x,y)>0 is not obtained in the Expression (2), that is, a case where else is obtained in the Expression (2) is a case where CMYK (x,y)>0 is obtained or a case where CMYK (x,y)=0 while P′ (x,y)=0 is obtained.

A value b of the ink amount CL1 of the first clear ink in the Expression (2) is a constant set in advance, and the value b may be determined in advance such that the degrees of the isotropy of the color ink and the fluorescent ink are close to each other. For example, as indicated in the measurement result in FIG. 9A, the degree of the isotropy of the fluorescent ink is close to the degree of the isotropy of the paper white in a case where the ink amount of the first clear ink is the printing duty equivalent value of 70%. Therefore, the value b in the Expression (2) may be determined to be a value corresponding to the printing duty equivalent value of 70%.

Note that, in the present embodiment, it is described that the value a and the value b indicating the ink amount are constants. With the overcoating with the clear ink, the resin component in the clear ink coats a surface of the color ink or the fluorescent ink, and the refractive index and the irregularities of the surface are changed. Under the above-described conditions of the measurement (the printing medium, the ink, and the like), the surface state made by the clear ink is changed mainly depending on the ink amount of the clear ink although it is affected a little by an ejection amount of the color ink CMYK or the fluorescent pink ink as a background. The reason may be that the layer of the clear ink has a role similar to that of a filter. Therefore, it is still possible to obtain an effect of making the degree of the isotropy even also in a case where the ink amount of the clear ink is a constant.

In S1208, the printing data generation unit 1107 performs binarization processing on each of the data of the determined color ink amount CMYK (x,y) and data of the fluorescent ink amount P′ (x,y) and generates the printing data of each ink. In a case where the processing of S1206 and S1207 is performed, the binarization processing is also performed on each data of the ink amount CL1 (x,y) of the first clear ink and the ink amount CL2 (x,y) of the second clear ink, and the printing data of each clear ink is generated. As indicated in FIG. 4, the printing data is the data indicating ON or OFF of the ink in each pixel. The method of generating the printing data from the data of the ink amount may be the same for each ink.

The output unit 1108 outputs the printing data to the printing apparatus 111. The printing apparatus 111 prints the image on the printing medium based on the received printing data.

For example, after the processing in S1206 and S1207 is performed, the processing proceeds to S1208, the printing data is generated in S1208, and the image is printed by the printing apparatus 111 based on the generated printing data. In this case, in Embodiment 1, the region printed with the color ink CMYK is overcoated with the second clear ink. The region printed with the fluorescent ink (P) is overcoated with the first clear ink. In the paper white, no overcoating with the clear ink is performed. Note that, the ink amount of the clear ink may be determined in S1206 or S1207 such that the paper white is printed with either one of the first clear ink and the second clear ink.

FIG. 10B is a schematic view illustrating an effect obtained by the present embodiment. The fluorescent ink (P) has relatively greater isotropy than that of the color ink (M). Therefore, the printing region of the fluorescent ink (P) is overcoated with the first clear ink (CL1) having small isotropy. Additionally, the printing region of the color ink (M) is overcoated with the second clear ink (CL2) having great isotropy. With the printing as described above, it is possible to make the degrees of the isotropy of the color ink printing region and the fluorescent ink printing region close to each other.

The overcoating is performed in the multi-pass printing by performing printing with the color ink or the fluorescent ink in a first pass and then performing printing with the clear ink in a second pass.

Alternatively, printing with the clear ink may be performed in the first pass, and printing with the color ink or the fluorescent ink may be performed in the second pass. For example, in a case where a main component of the clear ink is solid resin, if the clear ink is applied in the first pass, the solid component remains on the printing medium. In a case where the color ink or the fluorescent ink applied in the second pass passes through the solid component, and the color material is fixed in the printing medium, an image structure is formed that looks as if the clear ink is overcoated regardless of the order of the inks.

Additionally, the degrees of the isotropy of the color ink printing region and the fluorescent ink printing region may be made close to each other by performing printing so as to mix the first clear ink having small isotropy into the fluorescent ink and performing printing so as to mix the second clear ink having great isotropy into the color ink. In the method of performing printing so as to mix the inks, for example, in the multi-pass printing to perform printing in two passes, the second clear ink is applied after the color ink in the first pass. Additionally, likewise, the second clear ink is applied after the color ink also in the second pass to form a multi-layered structure. In a case where there is a short interval between the landing of the color ink and the second clear ink onto the printing medium, it is possible to achieve a state in which the inks are substantially mixed with each other on the printing medium.

As described above, according to the present embodiment, it is possible to control the deviation angle characteristics by using the clear ink for the color ink and the fluorescent ink having different deviation angle characteristics (degrees of the isotropy). Therefore, it is possible to make the deviation angle characteristics of the color ink printing region and the fluorescent ink printing region close to each other. Thus, it is possible to make the degrees of the change in the brightness of the color ink printing region and the fluorescent ink printing region on the printed product close to each other in a case where the observation angle (the acceptance angle) is changed. Therefore, it is possible to suppress the image defect of the printed product such as inverted tones and unbalanced colors in a case where the observation angle is changed.

Note that, the deviation angle characteristics of the printing region of each ink are changed depending on a type of the printing medium because it is affected by irregularities of a background or variation in a thickness of the ink layer. Therefore, the ink amount of the clear ink may be changed depending on the type of the printing medium.

Additionally, the value a of the ink amount of the first clear ink and the value b of the ink amount of the second clear ink may be changed based on an area of each of the fluorescent ink printing region and the color ink printing region. An effect of reducing the total consumption amount of the first clear ink and the second clear ink is expected by increasing the clear ink amount corresponding to the printing region with a small area.

### Embodiment 2

In the Embodiment 1, a method of suppressing the effect of the deviation angle characteristics (the isotropy) of the ink on the printed product by using the two types of the clear inks is described. In the present embodiment, a method of suppressing the effect of the deviation angle characteristics (the isotropy) of the ink by using one type of the clear ink is described. In the present embodiment, a difference from the Embodiment 1 is mainly described. A portion that is not particularly described has the same configuration and processing as that of the Embodiment 1.

### [Logical Configuration of Image Processing Apparatus]

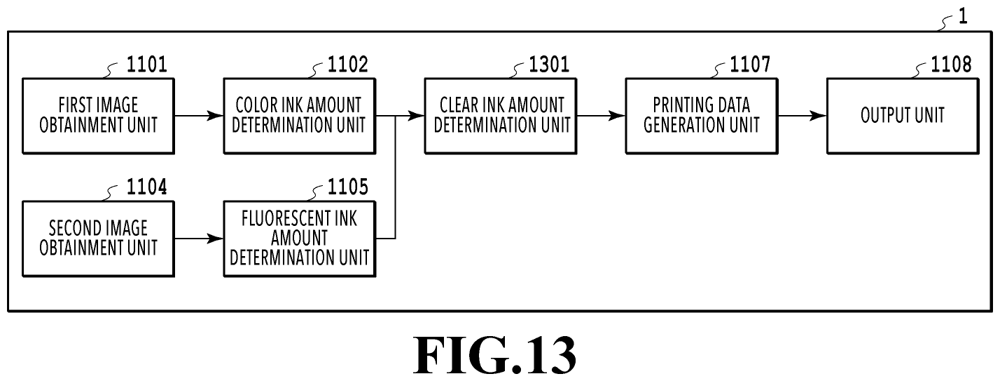

FIG. 13 is a diagram illustrating a logical configuration of the image processing apparatus 1 in the present embodiment. The same configuration as that in FIG. 11 is provided with the same reference numeral and described without details.

The image processing apparatus 1 includes the first image obtainment unit 1101, the color ink amount determination unit 1102, the second image obtainment unit 1104, the fluorescent ink amount determination unit 1105, a clear ink amount determination unit 1301, the printing data generation unit 1107, and the output unit 1108.

The clear ink amount determination unit 1301 determines the ink amount of the clear ink applied to each of the region printed with the color ink CMYK and the region printed with the fluorescent ink (P).

### [Processing Flow]

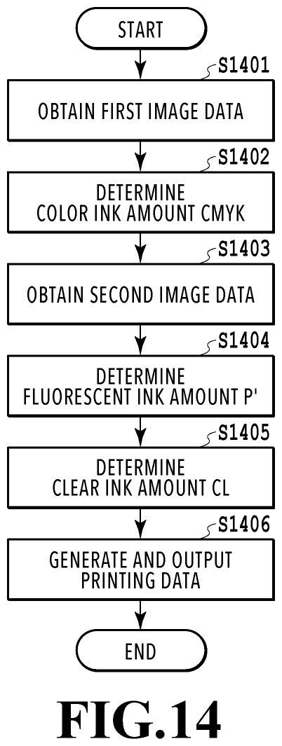

FIG. 14 is a flowchart illustrating a flow of processing in the present embodiment in which the image processing apparatus 1 generates the printing data and outputs the printing data.

S1401 to S1404 are steps similar to S1201 to S1204; for this reason, descriptions are omitted.

In S1405, the clear ink amount determination unit 1301 determines the clear ink amount CL (x,y) in a case of printing in the position (x,y).

In the present embodiment, the clear ink mounted in the printing apparatus 111 is either the first clear ink or the second clear ink. The ink amount of the clear ink determined in S1405 is determined depending on the relative degree of the isotropy of the clear ink mounted in the printing apparatus 111.

A ratio indicating the degree of the isotropy of the fluorescent ink is R_{P}, a ratio indicating the degree of the isotropy of the color ink is R_{CMYK}, and a ratio indicating the degree of the isotropy of the clear ink mounted in the printing apparatus 111 is R_{CL}. In a case where the isotropy of the clear ink mounted in the printing apparatus 111 is smaller than that of the other inks, that is, in a case where R_{P}>R_{CMYK}>R_{CL}, the ink amount CL (x,y) of the clear ink is calculated based on Expression (3). The ratio R is obtained based on R=Y₀₋₇₅/Y₀₋₄₅ as described above. Y₀₋₄₅ is the luminance measured at the incident angle of 0° and the acceptance angle of 45°, and Y₀₋₇₅ is the luminance measured at the incident angle of 0° and the acceptance angle of 75°. In other words, in a case where the clear ink mounted in the printing apparatus 111 is the first clear ink, the ink amount CL (x,y) of the clear ink is calculated based on the Expression (3). The first clear ink corresponds to the clear ink used in forming the sample No. 8 in FIG. 9A. Note that, it is assumed that the fluorescent ink has greater isotropy than that of the color ink CMYK.

$$\begin{matrix}if {P}^{′} ( x , y ) > 0 , CL ( x , y ) = a \\ else CL ( x , y ) = b\end{matrix} \qquad Expression ( 3 )$$

In the Expression (3), a>b is obtained, and b may be 0. The Expression (3) indicates that a greater amount of the clear ink is applied to the fluorescent ink printing region having great isotropy than to the other region (the paper white or the color ink printing region).

It is assumed that the data of the image with a mix of the fluorescent ink printing region in which printing is performed with the fluorescent ink of the ink amount used to generate the sample No. 2 in FIG. 9A and the color ink printing region in which printing is performed with the color ink of the ink amount used to generate the sample No. 3 is inputted. In this case, the printing data is generated such that the first clear ink (CL1) having small isotropy is applied more to the fluorescent ink region than to the color ink printing region.

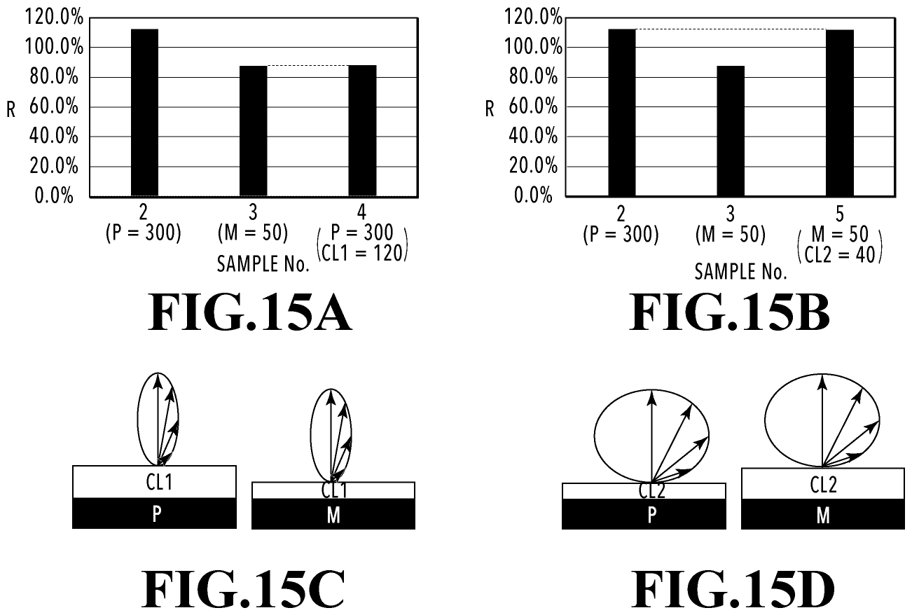

FIG. 15C is a schematic view illustrating an effect obtained by the present processing. As described above, since the isotropy of the first clear ink (CL1) is relatively small, it is possible to reduce the isotropy of the printing region of the fluorescent ink (P) by overcoating the printing region of the fluorescent ink (P) with a proper amount of the first clear ink (CL1). Therefore, it is possible to make the degree of the isotropy of the entire printed product close to the isotropy of the color ink (M).

FIG. 15A is a bar graph indicating the value of the ratio R of each of the samples No. 2, No. 3, and No. 4 indicated in FIG. 9A. The sample No. 4 is a sample obtained by overcoating the sample No. 2 with the first clear ink (CL1) of an ink amount of the printing duty equivalent value of 120%. It is indicated that, compared with the sample No. 2 printed with only the fluorescent ink (P) having great isotropy, the sample No. 4 has a substantially equal degree of the isotropy to that of the color ink (M).

In a case where b=0 is obtained in the Expression (3), the isotropy of the fluorescent ink printing region and the isotropy of the color ink printing region are substantially equal to each other; therefore, the degree of the change in the brightness due to the change in the observation angle in the two regions are equal to each other, and it is possible to suppress the image defect such as inverted tones and unbalanced colors. In a case where b=0 is obtained, the value a in the Expression (3) may be determined to be a value corresponding to the printing duty equivalent value of 120% so as to achieve the state of the sample No. 4. Note that, the value a in the Expression (3) may be determined to be a smaller ink amount than the exemplified ink amount. Even with the small ink amount of the clear ink, the difference in the isotropy is still reduced, and it is possible to suppress the image defect.

Additionally, for example, there may be a case where applying the clear ink also to the color ink printing region and the paper white is desired for reason of a measure of rubbing fastness. In such a case, b>0 may be obtained in the Expression (3) so as to apply the first clear ink also to the color ink printing region. In a case where b>0 is obtained in the Expression (3), it is possible to reduce the difference in the isotropy between two regions by increasing the value a than that in a case where b=0 is obtained to increase the amount of the first clear ink applied to the fluorescent ink region. In this case, the value a and the value b may be determined in advance such that the isotropy of the color ink and the isotropy of the fluorescent ink are close to each other.

On the other hand, in a case where the isotropy of the clear ink mounted in the printing apparatus 111 is greater than that of the other inks, that is, in a case where R_{CL}>R_{P}>R_{CMYK}, in S1405, the ink amount CL (x,y) of the clear ink is calculated based on Expression (4). In other words, in a case where the clear ink mounted in the printing apparatus 111 is the second clear ink, the ink amount CL (x,y) of the clear ink is calculated based on the Expression (4). The second clear ink corresponds to the clear ink used in forming the sample No. 9 in FIG. 9A.

$$\begin{matrix}if CMYK ( x , y ) > 0 , CL ( x , y ) = a \\ else CL ( x , y ) = b\end{matrix} \qquad Expression ( 4 )$$

In the Expression (4), a>b is obtained, and b may be 0. The Expression (4) indicates that the color ink printing region of small isotropy is printed with a greater amount of the clear ink than that in the other region (the paper white or the fluorescent ink printing region).

FIG. 15D is a schematic view illustrating an effect obtained by the present processing. As described above, since the isotropy of the second clear ink (CL2) is relatively great, it is possible to increase the isotropy of the printing region of the color ink (M) by applying a proper amount of the second clear ink (CL2) to the printing region of the color ink (M). Therefore, it is possible to make the degree of the isotropy of the entire printed product close to the isotropy of the fluorescent ink (P).

FIG. 15B is a bar graph indicating the value of the ratio R of each of the samples No. 2, No. 3, and No. 5 indicated in FIG. 9A. The sample No. 5 is a sample obtained by overcoating the sample No. 3 with the second clear ink (CL2) of an ink amount of the printing duty equivalent value of 40%. It is indicated that, compared with the sample No. 3 printed with only the color ink (M) having small isotropy, the sample No. 5 has a substantially equal degree of the isotropy to that of the fluorescent ink (P).

In a case where b=0 is obtained in the Expression (4), the value a in the Expression (4) may be determined in advance to be a value corresponding to the printing duty equivalent value of 40%. Alternatively, as with the case where the first clear ink is mounted, an ink amount less than the exemplified ink amount may be determined. In the Expression (4), in a case where b>0 is obtained, the value a may be determined to be greater than that in a case where b=0 is obtained.

S1406 is processing similar to S1208, and the printing data generation unit 1107 generates the printing data of each ink. That is, the binarization processing is performed on each of the determined data of the color ink amount CMYK (x,y), data of the fluorescent ink amount P′ (x,y), and the ink amount CL (x,y) of the clear ink mounted, and the printing data of each ink is generated. The output unit 1108 outputs the printing data to the printing apparatus 111. The printing apparatus 111 prints the image based on the received printing data.

Note that, the flowchart in FIG. 14 may include a step of determining whether to use the clear ink in printing the image like S1205 in FIG. 12. Then, S1405 may be performed if it is determined that the clear ink is to be used.

As described above, according to the present embodiment, it is possible to control the deviation angle characteristics of the printed product to be made uniform by applying a single type of the clear ink to the printing regions of the color ink and the fluorescent ink having different deviation angle characteristics. That is, according to the present embodiment, the degrees of the change in the brightness of the color ink printing region and the fluorescent ink printing region in a case where the observation angle is changed are close to each other, and thus it is possible to suppress the image defect such as inverted tones and unbalanced colors in a case where the observation angle is changed.

Note that, in the present embodiment, it is described that the clear ink mounted in the printing apparatus 111 is the first clear ink or the second clear ink, and the isotropy of the clear ink is smaller or greater than both the color ink and fluorescent ink. In addition, the clear ink mounted in the printing apparatus 111 may be a clear ink that is different from the first clear ink and the second clear ink and may be a clear ink that has the isotropy between the isotropy of the color ink and the isotropy of the fluorescent ink.

In this case, the ink amount CL (x,y) of the clear ink may be determined by using the value of the ratio R indicating the degree of the isotropy of each ink. For example, the clear ink amount may be determined depending on whether a difference (R_{CL}−R_{P}) between the ratio R_{CL} of the clear ink and the ratio R_{P} of the fluorescent ink is greater than a difference (R_{CL}−R_{CMYK}) between the ratio R_{CL} of the clear ink and the ratio R_{CMYK} of the color ink. For example, in a case where (R_{CL}−R_{P})> (R_{CL}−R_{CMYK}), the ink amount CL (x,y) of the clear ink may be determined based on the Expression (3) such that a greater amount of the clear ink is applied to the fluorescent ink (P) printing region. On the other hand, in a case where (R_{CL}−R_{P})< (R_{CL}−R_{CMYK}), the ink amount CL (x,y) of the clear ink may be determined based on the Expression (4) such that a greater amount of the clear ink is applied to the color ink CMYK printing region. It is expected that the degree of the isotropy is made entirely uniform efficiently by applying a greater amount of the mounted clear ink to the printing region of the ink that has the isotropy farther from that of the clear ink.

### Embodiment 3

In the above-described embodiment, a method of determining the ink amount of the clear ink depending on the fluorescent ink printing region and the color ink printing region is described. In the present embodiment, a method of determining a proper ink amount of the clear ink taking into consideration a difference in the deviation angle characteristics depending on the ink amount in each position in the image is described. In the present embodiment, a difference from the Embodiment 1 is mainly described. A portion that is not particularly described has the same configuration and processing as that of the Embodiment 1.

### [Logical Configuration of Image Processing Apparatus]

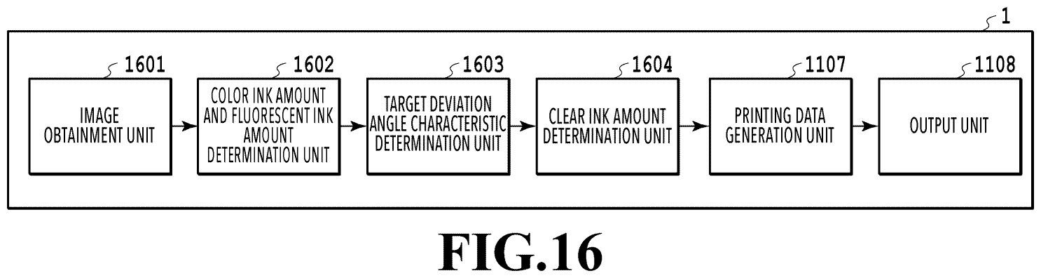

FIG. 16 is a diagram illustrating a logical configuration of the image processing apparatus 1 in the present embodiment. The same configuration as that in FIG. 11 is provided with the same reference numeral and described without details. The image processing apparatus 1 includes an image obtainment unit 1601, a color ink amount and fluorescent ink amount determination unit 1602, a target deviation angle characteristic determination unit 1603, a clear ink amount determination unit 1604, the printing data generation unit 1107, and the output unit 1108.

The image obtainment unit 1601 obtains the image data. The color ink amount and fluorescent ink amount determination unit 1602 determines the corresponding ink amount of each of the color inks CMYK and the fluorescent ink from the image data. The target deviation angle characteristic determination unit 1603 determines the target deviation angle characteristics in all the pixels in the image. The clear ink amount determination unit 1604 determines the ink amount in printing the clear ink in each pixel based on the target deviation angle characteristics.

### [Processing Flow]

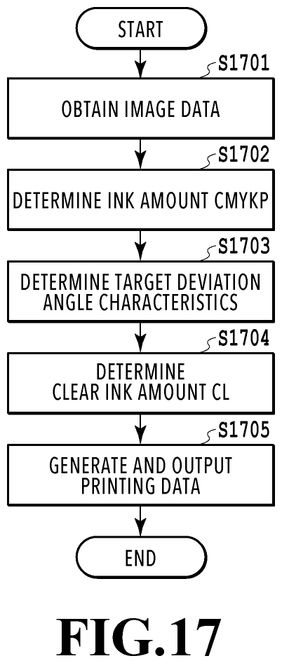

FIG. 17 is a flowchart illustrating a flow of processing in the present embodiment in which the image processing apparatus 1 generates the printing data and outputs the printing data.

The clear ink mounted in the printing apparatus 111 is either the first clear ink or the second clear ink. In the present embodiment, it is described that the first clear ink (CL1) having the isotropy smaller than that of the other inks is mounted.

In S1701, the image obtainment unit 1601 obtains the image to be printed on the printing medium, that is, the image data as the printing target from the external apparatus such as the HDD 113. The image data obtained in S1701 is, for example, data of the RGB image, and it is described assuming that there is no layer of P.

In S1702, the color ink amount and fluorescent ink amount determination unit 1602 determines an ink amount CMYKP (x,y) in the position (x,y) of the pixel. The ink amount CMYKP (x,y) is formed of five signal values, and each signal value is data of the density value of each of the color inks C, M, Y, and K and the fluorescent ink P. The color ink amount and fluorescent ink amount determination unit 1602 determines the ink amount CMYKP (x,y) by using a common method such as using an LUT in which RGB and CMYKP prepared in advance are associated with each other. In generating the printing data of the printing apparatus in which the special color ink is mounted, in some cases, the amount of the inks including the special color ink is converted from the data of the RGB image. It is possible to achieve wide color gamut expression including bright pink by expressing the colors with an ink group including the fluorescent ink P.

In S1703, the target deviation angle characteristic determination unit 1603 determines a ratio RT indicating the target deviation angle characteristics in the entire region in the image. The ratio Rr as the target may be an arbitrary value. For example, in a case where the isotropy of the clear ink mounted in the printing apparatus 111 is smaller than that of the other inks, it is possible to determine the ratio RT as described below.

First, a ratio R_{CMYKP} (x,y) indicated by the deviation angle characteristics (the degree of the isotropy) in a case where printing is performed with the ink amount CMYKP (x,y) determined in S1702 is determined for each position (x,y) of the pixel.

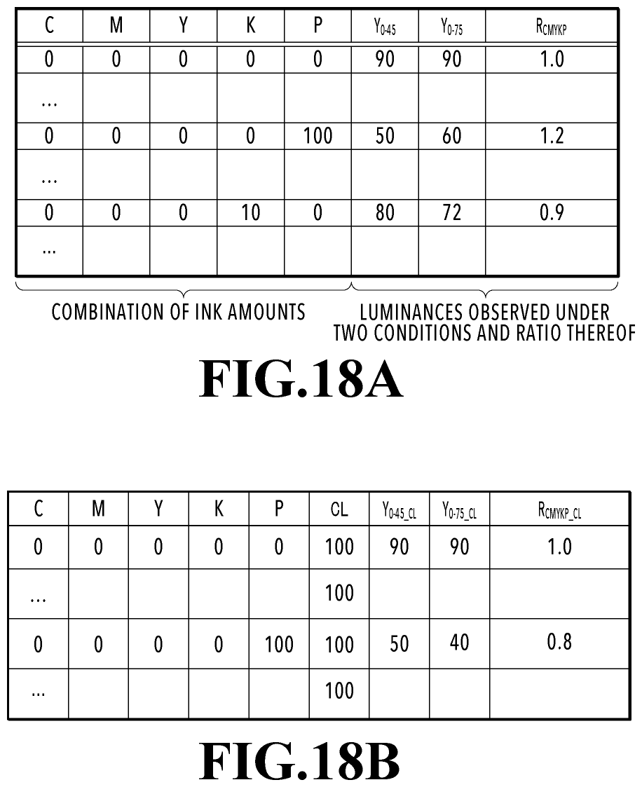

FIG. 18A is a diagram illustrating an example of the LUT in which a combination of the ink amounts of the inks CMYKP and the ratio R_{CMYKP} in a case where printing is performed with the corresponding ink amount are associated with each other. With this LUT, it is possible to determine the ratio R_{CMYKP} (x,y) in the position of each pixel from the ink amount CMYKP (x,y).

A column C, a column M, a column Y, a column K, and a column P of the LUT in FIG. 18A each hold the ink amount of each ink by the unit of a predetermined grid. The column C holds the ink amount of the color ink (C). The column M holds the ink amount of the color ink (M). The column Y holds the ink amount of the color ink (Y). The column K holds the ink amount of the color ink (K). The column P holds the ink amount of the fluorescent ink (P).

A column Y₀₋₄₅ holds the luminance at the incident angle of 0° and the acceptance angle of 45° in a case where printing is performed with the ink amounts held in the column C, the column M, the column Y, the column K, and the column P. A column Y₀₋₇₅ holds the luminance at the incident angle of 0° and the acceptance angle of 75° in a case where printing is performed with the ink amounts held in the column C, the column M, the column Y, the column K, and the column P. A column R_{CMYKP} holds a value of the ratio R_{CMYKP} (R_{CMYKP}=Y₀₋₇₅/Y₀₋₄₅).

The value indicating the ink amount that is held by the LUT in FIG. 18A is the printing duty equivalent value [%]. Therefore, the ratio R_{CMYKP} (x,y) is determined with reference to the LUT in FIG. 18A after the ink amount CMYKP (x,y) determined in S1702 is converted into the printing duty equivalent value. Additionally, in the present embodiment, CMYK and the P are not exclusive and are mixed in some cases.

Therefore, in the LUT in FIGS. 18A and 18B, a row holding a value greater than 0 in the column P may hold a value greater than 0 in each column of CMYK.

The target deviation angle characteristic determination unit 1603 calculates the ratio RT indicating the target deviation angle characteristics by plugging determined R_{CMYKP} (x,y) of each pixel into Expression (5).

$$R T = Min ( {R}_{CMYKP} ( x , y ) ) \qquad Expression ( 5 )$$

In the Expression (5), Min is a function calculating the minimum value. That is, the minimum value of the ratio R_{CMYKP} (x,y) in the positions of all the coordinates in the image is determined as the ratio Rr indicating the target deviation angle characteristics. In the later-described processing, printing is performed with a greater amount of the clear ink in the position of the ink amount having great isotropy to make the deviation angle characteristics close to the target deviation angle characteristics.

In S1704, the clear ink amount determination unit 1604 determines the ink amount CL (x,y) of the first clear ink for all the positions in the image in a case of performing printing in the position (x,y).

First, as for the position (x,y) as the target, a ratio R_{CMYKP_CL} (x,y) indicating the deviation angle characteristics (the isotropy) in a case where a predetermined ink amount of the first clear ink is applied to the region printed with the ink amount CMYKP (x,y) determined in S1702 is determined. In the present embodiment, the following descriptions are given assuming that the predetermined ink amount is 100.

FIG. 18B is a diagram illustrating an example of the LUT in which the combination of the ink amounts of the inks CMYKP and the ratio R_{CMYKP_CL} in a case where the ink amount 100 of the first clear ink is applied to the region printed with the corresponding ink amount are associated with each other. With this LUT, it is possible to determine the ratio R_{CMYKP_CL} (x,y) in the position (x,y) from the ink amount CMYKP (x,y) determined in S1702.

The column C, the column M, the column Y, the column K, and the column P of the LUT in FIG. 18B each hold the ink amount of each ink by the unit of the predetermined grid. The column C holds the ink amount of the color ink (C). The column M holds the ink amount of the color ink (M). The column Y holds the ink amount of the color ink (Y). The column K holds the ink amount of the color ink (K). The column P holds the ink amount of the fluorescent ink (P). A column CL holds an ink amount CL100 of the first clear ink uniformly.

A column Y_{0-45_CL} holds the luminance at the incident angle of 0° and the acceptance angle of 45° in a case where printing is performed with the ink amounts held in the column C, the column M, the column Y, the column K, the column P, and the column CL. A column Y_{0-75_CL} holds the luminance at the incident angle of 0° and the acceptance angle of 75° in a case where printing is performed with the ink amounts held in the column C, the column M, the column Y, the column K, the column P, and the column CL. A column R_{CMYKP_CL} holds a value of the ratio R_{CMYKP_CL} (R_{CMYKP_CL}=Y_{0-75_CL}/Y_{0-45_CL}).

Additionally, the clear ink amount determination unit 1604 calculates the ink amount CL (x,y) of the first clear ink in a case of printing in the position (x,y) by using Expression (6). In the Expression (6), R_{CMYKP} (x,y) is determined with reference to the LUT in FIG. 18A in which each ink amount of CMYKP and the ratio R_{CMYKP} are associated with each other.

$$CL ( x , y ) = ( 100 / ( {R}_{CMYKP \_ CL} ( x , y ) - {R}_{CMYKP} ( x , y ) ) ) \cdot ( {R}_{T} - {R}_{CMYKP} ( x , y ) ) \qquad Expression ( 6 )$$

The Expression (6) is an expression of linear interpolation used commonly. In a case where the deviation angle characteristics are varied linearly according to the ink amount of the clear ink, it is possible to determine the ink amount CL (x,y) of the clear ink to be the ratio RT indicating the target deviation angle characteristics by using the Expression (6).

S1705 is processing similar to S1208, and the printing data generation unit 1107 generates the printing data of each ink. That is, the binarization processing is performed on each of the determined data of the ink amount CMYKP (x,y) and the ink amount CL (x,y) of the clear ink, and the printing data of each ink is generated. The output unit 1108 outputs the printing data to the printing apparatus 111. The printing apparatus 111 prints the image based on the received printing data.

Note that, the flowchart in FIG. 17 may include a step of determining whether to use the clear ink in printing the image like S1205 in FIG. 12. Then, S1704 may be performed if it is determined that the clear ink is to be used.

As described above, according to the present embodiment, it is possible to determine the ink amount of the clear ink in each pixel so as to be close to the target deviation angle characteristics based on the deviation angle characteristics according to the ink amount of the color ink and the fluorescent ink in each pixel. Additionally, it is possible to obtain an effect of making the deviation angle characteristics uniform over the entire printed product even in a case where the deviation angle characteristics of the paper white and each ink are different from each other considerably. Thus, over the entire printed product, it is possible to suppress the image defect such as inverted tones and unbalanced colors in a case where the observation angle is changed.

### OTHER EMBODIMENTS

Note that, the functional unit of the image processing illustrated in FIGS. 11, 13, and 16 may be implemented in the printing apparatus 111.

In the above-described embodiment, it is described that the isotropy of the fluorescent ink is greater than the isotropy of the color ink. It is needless to say that, even in a case where the isotropy of the color ink is greater than the isotropy of the fluorescent ink, it is possible to obtain a similar effect by inverting the relationship between the color ink and the fluorescent ink in the above-described embodiment.

In the above-described embodiment, the degree of the isotropy is indicated by a ratio of the luminance at two different observation angles; however, instead of the luminance, another feature amount indicating brightness such as lightness and density may be used. Additionally, the degree of the isotropy may be indicated by a difference between feature amounts at different observation angles. Moreover, in order to take into consideration the responsiveness and linearity with respect to the clear ink amount, a numerical value may be corrected by y conversion processing, for example.

According to a technique of the present disclosure, it is possible to suppress an image printed with a color ink and a fluorescent ink from looking defective depending on an observation angle.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-175107 filed Oct. 10, 2023, which is hereby incorporated by reference wherein in its entirety.

What is claimed is:

1. An image processing apparatus, comprising:
a generation unit configured to generate printing data to cause a printing apparatus to apply an ink based on data of an image, the printing apparatus printing the image on a printing medium by using a fluorescent ink including a fluorescent component, a color ink, and a clear ink; and
an output unit configured to output the printing data, wherein
the generation unit generates the printing data to cause the printing apparatus to apply the clear ink so as to reduce a difference between a degree of change in brightness depending on an observation angle in a region to which the fluorescent ink is applied and a degree of change in brightness depending on the observation angle in a region to which the color ink is applied.

2. The image processing apparatus according to claim 1, wherein
the clear ink includes a first clear ink and a second clear ink having greater isotropy than that of the first clear ink, and
the generation unit generates the printing data such that the first clear ink is applied to the region to which the fluorescent ink is applied, and the second clear ink is applied to the region to which the color ink is applied.

3. The image processing apparatus according to claim 2, wherein
the second clear ink is a clear ink having greater isotropy than that of the fluorescent ink and the color ink.

4. The image processing apparatus according to claim 2, wherein
the first clear ink is a clear ink having smaller isotropy than that of the fluorescent ink and the color ink.

5. The image processing apparatus according to claim 1, wherein
the clear ink is a clear ink having smaller isotropy than that of the fluorescent ink and the color ink, and
the generation unit generates the printing data such that a greater amount of the clear ink is applied to the region to which the fluorescent ink is applied than that to a region to which no fluorescent ink is applied.

6. The image processing apparatus according to claim 1, wherein
the clear ink is a clear ink having greater isotropy than that of the fluorescent ink and the color ink, and
the generation unit generates the printing data such that a greater amount of the clear ink is applied to the region to which the color ink is applied than that to a region to which no color ink is applied.

7. The image processing apparatus according to claim 1, wherein
the generation unit compares a first value that is a difference of a degree of isotropy between the fluorescent ink and the clear ink with a second value that is a difference of a degree of the isotropy between the color ink and the clear ink,
in a case where the first value is greater than the second value, generates the printing data such that a greater amount of the clear ink is applied to the region to which the fluorescent ink is applied than that to a region to which no fluorescent ink is applied, and
in a case where the second value is greater than the first value, generates the printing data such that a greater amount of the clear ink is applied to the region to which the color ink is applied than that to a region to which no color ink is applied.

8. The image processing apparatus according to claim 1, wherein
the data of the image includes first image data in which a pixel value is a value corresponding to the color ink and second image data in which the pixel value is a value corresponding to the fluorescent ink, and the region to which the color ink is applied holds the pixel value of each pixel to prevent applying of no fluorescent ink.

9. The image processing apparatus according to claim 1, further comprising:
a first ink amount determination unit configured to determine ink amounts of the color ink and the fluorescent ink for each pixel based on the data of the image; and
a second ink amount determination unit configured to determine an ink amount of the clear ink for each pixel based on the ink amounts of the color ink and the fluorescent ink, wherein
the generation unit generates the printing data based on the determined ink amount of each ink.

10. The image processing apparatus according to claim 9, further comprising:
a determination unit configured to determine a target degree of isotropy, wherein
the second ink amount determination unit determines the ink amount of the clear ink such that the degree of the isotropy of the image becomes the target degree of the isotropy.

11. The image processing apparatus according to claim 10, wherein
the second ink amount determination unit determines for each pixel a first value indicating the degree of the isotropy in a case where the determined ink amounts of the color ink and the fluorescent ink are applied,
determines for each pixel a second value indicating the degree of the isotropy in a case where a predetermined ink amount of the clear ink and the determined ink amounts of the color ink and the fluorescent ink are applied, and
determines the ink amount of the clear ink based on the first value and the second value of each pixel and a value indicating the target degree of the isotropy.

12. The image processing apparatus according to claim 1, wherein
the printing apparatus is configured to be able to set either of a first mode in which printing is performed with the clear ink and a second mode in which printing is performed without the clear ink, and
in a case where the first mode is set in the printing apparatus, the generation unit generates the printing data to cause the printing apparatus to apply the clear ink.

13. The image processing apparatus according to claim 2, wherein
the degree of the isotropy is a third value indicating a degree of a second feature amount with respect to a first feature amount indicating brightness in a case of observation at a first observation angle, the second feature amount indicating brightness in a case of observation at a second observation angle greater than the first observation angle.

14. The image processing apparatus according to claim 13, wherein
the feature amount indicating the brightness is either of luminance, lightness, and density, and
the third value is either of a ratio of the second feature amount relative to the first feature amount and a difference between the first feature amount and the second feature amount.

15. The image processing apparatus according to claim 1, wherein
the color ink includes no fluorescent component, and the clear ink includes no color material.

16. The image processing apparatus according to claim 1, wherein
the color ink is a subtractive color mixture ink and is an ink having smaller isotropy than that of the fluorescent ink.

17. An image processing method, comprising:
generating printing data to cause a printing apparatus to apply an ink based on data of an image, the printing apparatus printing the image on a printing medium by using a fluorescent ink including a fluorescent component, a color ink, and a clear ink; and
outputting the printing data, wherein
the printing data to cause the printing apparatus to apply the clear ink is generated so as to reduce a difference between a degree of change in brightness depending on an observation angle in a region to which the fluorescent ink is applied and a degree of change in brightness depending on the observation angle in a region to which the color ink is applied.

18. A non-transitory computer readable storage medium storing a program which causes a computer to perform an image processing method, the image processing method comprising:
generating printing data to cause a printing apparatus to apply an ink based on data of an image, the printing apparatus printing the image on a printing medium by using a fluorescent ink including a fluorescent component, a color ink, and a clear ink; and
outputting the printing data, wherein
the printing data to cause the printing apparatus to apply the clear ink is generated so as to reduce a difference between a degree of change in brightness depending on an observation angle in a region to which the fluorescent ink is applied and a degree of change in brightness depending on the observation angle in a region to which the color ink is applied.
